(19) United States
(12) Patent Application Publication
(10) Pub. No.: US 2004/0026671 A1
(43) Pub. Date: Feb. 12, 2004

(54) Phosphorus containing materials, their preparation and use

(76) Inventors: Hugues Van den Bergen, Brussels (BE); Jean-Claude Vanovervelt, Warchin (BE)

Correspondence Address: WENDEROTH, LIND & PONACK, L.L.P., 2033 K STREET N. W., SUITE 800, WASHINGTON, DC, 20006-1021, US

(21) Appl. No.: 10/240,676

(22) PCT Filed: Mar. 30, 2001
(86) PCT No.: PCT/EP01/03644

(30) Foreign Application Priority Data
Apr. 3, 2000 (EP) 00107232.1

(51) Int. Cl. C09K 21/00

(52) U.S. Cl. 252/601

(57) ABSTRACT

There is described a co-polymerisable phosphorus containing polymer precursor which comprises: a) a polymerisable unsaturated bond; b) a oxycarbonyl or iminocarbony group; and c) a free hydroxy group or a functional group obtainable by reaction of a free hydroxy group with a suitable electrophile; and d) a terminal phosphorus and oxygen containing group located at the end of a carbon chain and comprising at least one group selected from: hydroxy phosphorus and an optionally substituted hydrocarbyl group attached to a phosphorus atom through an oxy group; where the polymer precursor: is substantially free of halo comprising species; has a molecular weight (Mn if a polymer) of from about 200 to about 5,000 daltons; and optionally, has a Hoppler viscosity measured at 25° C. of less than about 14,000 mPa.s. These polymer precursors are obtainable as the product of a reaction between an optionally substituted terminal phosphate or H-phosphonate ester and compound comprising at least one oxiranyl, preferably epoxy, ring adjacent an alkylidenylcarbonyloxy group. The polymer precursors can be copolymerised with other monomers to produce copolymers such as phosphorus containing polyurethanes which for example have use as flame retardants, anti-corrosives, pigment dispersants and/or adhesion promoters.

The present invention is directed toward phosphorus containing organic materials which may be compounds, polymers and/or mixtures thereof. The materials of the invention preferably impart and/or exhibit resistance to attack, for example they may be useful as flame retardant additives and/or materials. The materials of the invention may be formed by using polymer precursors (also of the invention) to form polymeric materials of the invention (such as copolymers) either directly or via formation of polymerisable intermediate(s).

There is a continuing need for new materials exhibiting improved resistance to attack, for example as improved flame retardants. Furthermore, there is a need for such materials which are also polymerisable, for example in the form of a coating, as a thin or thick layer. Polymerisation may be achieved by any suitable method. Preferred methods are thermal curing or irradiation, for example using ultraviolet radiation and/or ionising radiation, such as gamma rays, X-rays and/or electron beam(s).

The use of phosphorus-containing materials as flame retardants is well known. It is believed that in the presence of a flame source they act by, for example, forming phosphoric and polyphosphoric acids of low volatility which catalyse the decomposition of organic compounds to carbon (char) and water. Non-volatile phosphorus-containing compounds may also coat the char to protect it from further oxidation, and this may act as a physical barrier and/or reduce the permeability of the char. It is believed that in general the greater the phosphorus content of the material the better its flame resistance.

It will be appreciated that the desire for imparting improved flame resistance by incorporating an increasing phosphorus content must also be balanced by the corresponding reduction in the proportion of other components in the treated or modified material. The overall physicochemical and mechanical properties of the resultant material must be maintained within limits acceptable for its end use.

Many previous phosphorus-containing flame retardants have been non-copolymerisable compounds and/or required additional halogenated compounds as additives to improve flame retardant properties. In conventional plastics, flame retardation of polymers has been achieved by the use of flame retardants as additives, which are physically blended as a mixture with the polymer. However, conventional flame retardant additives suffer from several drawbacks. Prior art additives modify the physical and mechanical properties of the polymer often in an undesirable or unpredictable way. There may also be compatibility problems with the additive and the polymer to which it is added. Additives can also be unacceptable for certain applications, especially for coatings, as they can migrate through the coating to the surface which can lead to blooming phenomena. Additives may also discolour the composition which is a particular issue for clear coatings. Furthermore the use of certain additives may not work well with radiation curable materials since the high concentration of additives could lead to incomplete curing because the additive absorbs radiation.

For all these reasons, copolymerisable compounds containing phosphorus have been developed in which the phosphorus atom is linked to the backbone of a polymer precursor through a chemical reaction in which a covalent bond is formed. This method of incorporating phosphorus is advantageous because as the phosphorus moieties are permanently linked to the backbone of the resultant polymer, there is no blooming effect. There is also a reduced influence upon the physical and mechanical properties of the resultant polymer. Until now phosphorus has been introduced into polymeric materials by copolymerisation of phosphorus containing monomers which were polyols and/or contained halogen groups, however both these monomer types have disadvantages.

The use of a phosphorous containing polyol-as the monomer limits the range and type of polymers which can be synthesised.

The use of a halogen containing monomer to prepare a flame retardant is also undesirable. In a fire halogen groups can generate toxic and corrosive combustion products. These corrosive gases, in addition to their toxic properties, cause significant damage to electronic components, present in particular in computers, which very often results in the loss of essential data and irreparable damage, often worse than the fire itself. The combustion products from halogen containing materials may even be as dangerous as combustion products from materials untreated with such flame retardants. It is also undesirable to use halogen in a flame retardant, or process for preparing it, for other reasons such as their potentially undesirable effect on the environment.

Coatings having flame-retardant properties have previously been obtained by polymerisation of compositions comprising phosphorus-comprising oligomers. WO 95/02004 (=U.S. Pat. No. 5,456,984 & U.S. Pat. No. 5,389,439) (DSM) discloses a composition comprising oligomers terminated by functional groups which can be copolymerised by irradiation. The oligomer is prepared by first reacting a polyisocyanate with a polyol containing a phosphonate ester group and then reacting the product with a hydroxylated acrylate. This process has various disadvantages. The phosphonated polyols used must first be prepared in the presence of a solvent and-a catalyst and these must be removed over a prolonged time (together with any reaction by-products) from the final product. The preparation uses alkylene oxides, the commonest of which are gases at atmospheric pressure such as ethylene oxide, and these reagents require a specific industrial plant with appropriate reactor vessels.

A phosphorus-comprising resin with flame-retardant properties has been described [D. Derouet, F. Morvan and J. C. Brosse, Journal of Applied Polymer Science, Vol. 62, 1855-1868 (1996)]. The process for the preparation of this resin comprises the partial reaction between an epoxide compound, bisphenol A 4,4′-diglycidyl ether, and a dialkyl phosphate. The phosphorus-comprising epoxy resin which is thus prepared can be polymerised by heating in the presence of a cross-linking agent, such as a diamine (4,4′-diaminodiphenyl sulphone) to produce a composition having flame-retardant properties. However, this resin cannot be polymerised by irradiation and cannot therefore be applied to heat-sensitive substrates, such as fabrics, wood or paper. Furthermore, this polymerisation technique is costly both in energy because of the heating and in time, as the kinetics of polymerisation by heating are much slower than those by irradiation. Finally, a major disadvantage of these resins is their low content of phosphorus, as the phosphorus is introduced to the epoxy resin by opening the epoxide group which decreases the concentration of epoxide groups necessary for the polymerisation.

Some methacrylated phosphorus containing compounds have been described in the literature.

The kinetics of the reaction of PhOP(═O)(OH)Me [methyl monophenyl phosphonate] has been studied by Pavlichenko et al. [Zh.Obshch.Khim. (1984), 54 (5), 1156-60]. This reaction does not use a phosphate as the reactant but a phosphonate. This paper does not suggest any flame retardant applications for this compound.

Phosphonate-containing photocurable compositions with good adhesion to metal have been described in JP 10-A-045856 (Daicel). Phosphoric acid (H₃PO₄) is reacted with Cyclomer A200 to give a phosphorus-containing resin that is copolymerised with for example a methacrylate derivative and a thermal initiator. The resin is then formulated with radiation curable monomers and photoinitiator. No phosphoric ester is used to make the resin and the free P—OH groups are not reacted. Copolymerisation occurs with other monomers. These compositions are adhesion promoters for which no flame retardant properties are described.

GB 2,172,889-A (Kao) (=JP 61-A-215398—Nippon Kagaku Kaishi) describes the production of phosphoric esters of formula

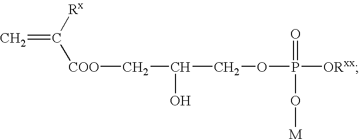

where R^{x} is H, Me and R^{xx} is C₁₋₃₆alkyl optionally substituted by at least one fluoro; and M is H, alkali metal, ammonium, alkylammonium, or a salt or alkanolamine. An exemplified phosphate is sodium dodecyl 3-hydroxy-3-methacryloxypropylphosphate. These esters are formed by reacting glycidyl methacrylate (also referred to herein as GMA) with a monoalkyl phosphoric acid metallic salt followed by polymerisation with radical initiator. This reference does not disclose a dialkyl phosphate but monoalkyl phosphates which either comprise a salt of a phosphate anion with M as the counter cation or still contain a free P-OH function (when M═H). No flame retardant applications are mentioned for this compound which is used to prepare an artificial polymeric membrane having surface-active properties.

There are other references in the prior art concerning the reaction of GMA with chlorophosphonates to produce phosphorus and chlorine containing monomers but for the reasons described herein these halogen containing monomers are disadvantageous for flame retardant applications.

Some phosphorous containing monomers have been described in the prior art for use as flame retardants. A flame retardant monomer can be considered as a compound having a copolymerisable functionality and a flame retardant moiety (such as phosphorus and halogen) preferably with a low molecular weight (<1000 g/mol). For higher molecular weight, it is conventional to refer to flame-retardant oligomers.

Diallyl phenylphosphonate and triallyl phosphate were prepared as long ago as 1940 as a flame retardant monomer [Toy A. D. F., Brown L., Ind. Eng. Chem., 40: 2276 (1948)].

Vinyl phosphorus monomers have been synthesised for use as flame retardants, for example bis(2-chloroethyl)vinyl phosphonate from Stauffer Chemicals [Kabachnick M. I., lzv.Akad Nauk.Otd.Khim., 2:233 (1947)]. Akzo sell a such monomer under the trade name FYROL Bis-Beta, which is made by dehydrochlorination of bis(2-chloroethyl)2-chloroethylphosphonate [Handbook of Organophosphorus Chemistry, Ed. Robert Engel (1992), p 709].

Phosphorus containing substituted styrenic monomers have been prepared which exhibit flame retardant properties [Rabinowitz R., Marus R., Pellon J., J.Polym.Scien., 2:1241 (1964)].

Some phosphorus (meth)acrylic monomers were developed in the sixties. The synthetic schemes are often complicated with moderate yields. Others preparations use pyridine or dichloromethane as a solvent with a catalyst and these preparations are not convenient for industrial use.

In the paper “Radiation cured halogen free flame retardant coating”, Radtech '90 North Am.Conf.Proc. (1990), Vol.2, 148-153; Bouwma et al. (TNO Centre for polymeric Materials/TNO Fibre Research Institute) tested the acrylated phosphonate compound dimethyl(2-acryloxyethyl)phosphonate (known hereinafter as “DAP” and described in DE 2313355 [Bayer]). These authors reported that there were few commercially available phosphorus containing compounds which also contained an acrylic or vinylic polymerisable group, mainly Fyrol-76 (a vinyl monomer available commercially from Stauffer) that had already been tested by several groups. The authors synthesised DAP in the lab using the reaction between dimethyl(2-hydroxyethyl)phosphonate (commercially available from FLUKA) and acryloyl chloride in dichloromethane in the presence of triethylamine. However DAP would be expensive to produce on a commercial scale because of the high price of the raw materials acryloyl chloride and dimethyl(2-hydroxyethyl)phosphonate. The process for producing DAP could also be environmentally undesirable because of the evolution of quantities of HCl gas.

In 1993, Boutevin et al. developed new acrylic phosphorus monomers [Boutevin B., Hamoui B., Parisi J -P., Polymer Bulletin 30, 243-248 (1993)]. Once again, this monomer has many disadvantages. It is made using a complicated three stage synthesis with halogenated compounds and thiols as starting materials. The reaction produces ethylbromide and HCl as side products and uses dichloromethane as solvent, so this procedure is inconvenient and too environmentally unfriendly to be scaled up for industrial production, for example due to the evolution of the corrosive HCl. The overall yield of this process is unacceptably low to produce this monomer economically from its raw materials on an industrial scale.

Polyepoxides reacted with acrylic acid and remaining epoxy groups reacted with phosphoric acid has been described for example in U.S. Pat. No. 4,434,278 (Celanese Corporation).

WO 96-07678 (Siemens) (=U.S. Pat. No. 5,804,860) describe certain UV curable phosphorus containing acrylate monomers for preparing flame retardant resins suitable for covering or encasing electronic components. One such monomer has the formula (I)

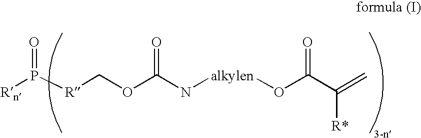

where n′ is 0 or 1; R′ is alkyl or aryl, R″ is —(CH₂)₁₋₅—; —O(CH₂)₁₋₅—; or —CH₂N[(CH₂)₁₋₅]₂—; R* is H or methyl; and “alkylen” denotes an divalent alkyl linking group. Monomers of formula (I) are formed from the reaction between a corresponding hydroxy functional phosphorus compound and a corresponding isocyantoalkyl(meth)acrylate or methacryloyl isocyanate. Also disclosed are monomers of formula(II)

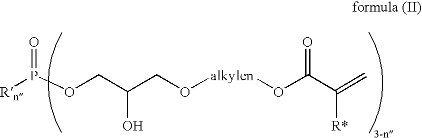

where n″ is 0, 1 or 2; R″, R* and “alkylen” are as given above. Monomers of formula (II) are formed from the reaction between a corresponding phosphorus containing epoxide with a corresponding hydroxy functional acrylate such as a hydroxy alkyl(meth)acrylate.

This document also teaches that resin compositions formed by and formulated with such monomers of formulae (I) or (II) also require a suitable filler such as aluminium hydroxide to give the required flame retardant properties to the composition. The monomers of formula (I) and (II) have many other disadvantages. For example if they comprise a phosphorus ester group it is formed by using as the phosphorus source, compounds of formulae (III) or (IV):

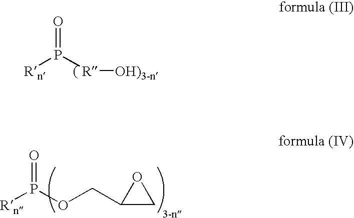

where n′, n″, R′, R″ and R* are as given above. When n′ or n″ is ≠0 compounds of formula (III) and (IV) can be difficult and expensive to prepare. When n′ or n″=0 compounds of formula (II) and (IV) are tri-substituted with acrylate groups at the phosphorus atom and this necessarily high acrylate content means such compounds have a corresponding low phosphorus content. Thus monomers made from them would also have a low phosphorus content which would result in an even lower phosphorus content in any polymers made from such monomers. Monomers of formula (I) also have a high viscosity which makes them unsuitable for use in many polymerisation processes e.g. as a monomer diluent. The patent states that a requirement in the epoxide reaction to produce monomers of formula (II) is a strong acid catalyst and the only catalyst described is an expensive and toxic hexafluoroantimonate. A further alternative reaction described in this reference to produce acrylate monomers of formula (II) uses an unsaturated acid chloride compound with a halo leaving group and thus the reaction evolves hydrogen halide and/or results in residual halo species in the monomer with the disadvantages discussed herein. Thus the processes for preparing monomers of formula (II) are less than satisfactory.

For these reasons the prior art monomers and/or compounds of formulae (I), (II), (III) and (IV) as described above are unsatisfactory and do not form part of the present invention.

WO 94-10223 (Siemens) describes a low-viscosity reaction resin system comprising a mixture of cationic photo-initiators with commercially available epoxy resins and phosphorus-containing glycidyl esters, such as phosphonic acid diglycidyl esters. The resin systems can be UV cured to form flame-resistant moulding materials.

WO 99-45061 (Siemens) describes a halogen-free flame resistant composite comprising a fibrous material and/or a woven material which is impregnated and hardened with a resin matrix. The resin matrix based on an epoxide/anhydride reactive resin made flame resistant by r actively inserting phosphorous compounds based on acid derivatives. The composite is stated to be useful as a component in the manufacture of vehicles where a low density material is desired.

JP 60(1985)-A-078,993 (Toho Chemicals) (e.g. as abstracted in CAS 103:178454j) discloses organophosphoric compounds of the following formula:

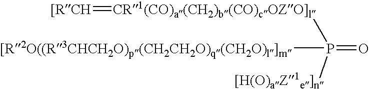

where R″═H, HO₂C; R″¹═H,Me,HO₂C; R″²═C₁₋₂₂hydrocarbon radical; R″³═Me,Et; Z″,Z″¹=alkylene; a″,b″,c″,d″,e″=0,1; a″+b″=0,1; b″+c″=0,1,2; a″+c″=2,1,0; 0<=p″<=20; 0<=q″<=10; 0<=r″<=5; l′=1,2,3; m″,n″=0,1,2; and l″+m″+n″=3. No uses for these compounds are described in the abstract. These compounds are different from the compounds claimed herein as for example moiety z″ in the above formula is an unsubstituted alkylene and does not contain a hydroxy group or derivative thereof (compare for example moiety Z′ in compounds of the invention represented by Formula 1 herein).

JP 10(1998)-A-316,896 (Sanyo Chemicals) (e.g. as abstracted in CAS 103:82935y) discloses compositions comprising a mixture of

A) copolymers formed from the following monomers

a) 0.05% to 5% of monomers which contain phosphate ester groups and having the formula: CH₂═CR′″¹CO₂CH₂CH(OH)CH₂OP(O)(OR′″²)(OR′″³) where R′″¹═H, Me; R′″²═C₁₋₂₄alkyl, C₆₋₂₀(alk)aryl, C₇₋₁₂aralkyl; R′″³═H, C₁₋₂₄alkyl, C₆₋₂₀(alk)aryl, C₇₋₁₂aralkyl

b) >=5% of vinyl monomers which contain a glycidyl group; and

c) >=50% of reactive vinyl monomers which contain a glycidyl group; and

B) carboxylic acids or anhydrides

at a glycidyl to carboxy group equivalent ratio of from 0.5 to 1.5.

These polymers are not stated to be flame retardants but are used in to form powder compositions with good pigment dispersibility and high temperature stability.

JP 1972-A-045,328 (Kanzaki) (e.g. as abstracted in CAS 78:57792z) discloses halogen containing phosphoric triesters which are prepared from halogen containing reagents and glycidyl methacrylate and then polymerised to produce a fire retardant. Such fire retardants are not halogen free and have the corresponding disadvantages described herein.

GB 1,317,843 (Ciba-Geigy) (=FR-A-2079361) discloses unsaturated phosphate ester containing amides with a terminal ethylene group which are used as monomers to prepare flame retardant phosphorous containing polyurethanes.

U.S. Pat. No. 3678012 (Matsuda et al) discloses phosphorous-containing curable products useful for preparing flame retardants prepared by mixing polymerisable monomers with the addition reaction products of an oxirane with a mixture of the polymerisable phosphates represented by the following two formulae:

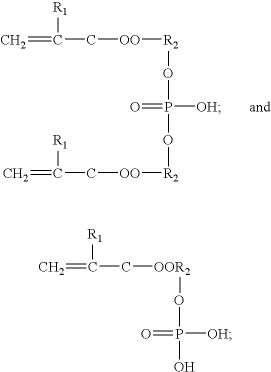

where R₁ represents H, Me; R₂ represents optionally halogenated lower (i.e. C₁₋₄)alkylene group. Optionally, polyhydric alcohols may be added to the mixture which is then reacted with a polyisocyanate. These compounds are different from those of the present invention because they do not contain a free C—OH group or derivative thereof on the carbon chain (i.e. R₂ is unsubstituted alkylene). This is in contrast to the acidic OH group(s) directly attached to the phosphorous atom.

EP 0273390 (Mitsubishi Rayon) (=U.S. Pat. No. 4,963,639) describes radiation curable resin compositions comprising certain amido hydroxy and polyol containing compounds, polyisocyanates, hydroxyl containing alkyl (meth)acrylate(s) and phosphoric esters of formula:

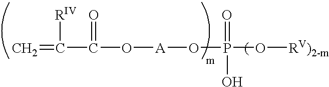

where R^{IV}═H or Me; A=divalent alcohol residue, R^{V}═H or C₁₋₄alkyl; and m=1 or 2. These compositions are stated to be useful in preparing magnetic recording media, there is no suggestion the compositions or any component(s) thereof could be used as flame retardants. The phosphoric esters represented above are also different from those of the present invention because the they do not envisage a free OH or derivative thereof on the carbon chain (A is a divalent alcohol residue which refers to an unsubstituted alkylene linking group between two oxygen atoms and is free of OH). This confirmed by the specific phosphoric esters disclosed in this reference which are free of non-phosphorous, acidic OH.

Thus prior art monomers for introducing phosphorous (and thus the desirable properties for the applications described herein such as flame retardancy) into a copolymer have various disadvantages. For example they contain halogen, they are produced from reactions of low yield using a multi step synthesis; they are prepared using undesirable (e.g. noxious or toxic) solvents; the processes for making them evolve undesirable by-products; expensive raw materials are required; they are prepared from multi-step reactions; they have low phosphorus content; they are too viscous to be used as monomer diluents and/or they require elaborate and expensive purification steps, such as chromatography, during their preparation.

Thus there is an ongoing need to find improved means for introducing phosphorous into organic materials to produce materials with improved properties effective for the uses and/or applications describe herein and which are capable of being produced on an industrial scale economically. A demand exists for a simple and economical process for the preparation of compounds which comprise phosphorus atoms and which can be used as starting material in the preparation of more complex compounds exhibiting useful properties for the applications and/or uses described herein (preferably for use in flame-retardancy).

It is an object of the invention to provide improved phosphorous containing materials which solve some or all of the problems described herein for the prior art.

The applicant has developed a new class of improved phosphorous containing materials which exhibit utility in the applications described herein, for example having improved flame retardant properties. The applicant has also discovered improved processes for preparing such materials which address some or all of the problems of the prior art such as those described herein. Surprisingly the applicant has also found that halo species can be substantially eliminated from these new materials with little or no adverse effect on their useful properties.

Therefore in a first aspect of the invention there is provided a co-polymerisable phosphorus containing polymer precursor which comprises:

a) a polymerisable unsaturated bond,

b) an oxycarbonyl or iminocarbonyl group;

c) a free hydroxy group or a functional group obtainable by reaction of a free hydroxy group with a suitable electrophile; and

d) a terminal phosphorus and oxygen containing group located at the end of a carbon chain and comprising at least one group selected from: hydroxy phosphorus and an optionally substituted hydrocarbyl group attached to a phosphorus atom through an oxy group;

where the polymer precursor:

is substantially free of halo comprising species;

has a molecular weight (Mₙ if a polymer) of from about 200 to about 5,000 daltons;

has a viscosity of less than about 14,000 mPa.s; and

the polymer precursor is other a compound represented by the following formula:

CH₂═CR′″¹CO₂CH₂CH(OH)CH₂OP(O)(OR′″²)(OR′″³)

where R′″¹═H, Me; R′″²═C₁₋₂₄alkyl, C₂₋₂₀(alk)aryl, C₇₋₁₂aralkyl; R′″³═H, C₁₋₂₄alkyl, C₆₋₂₀(alk)aryl, C₇₋₁₂aralkyl;

Preferred polymer precursors of the present invention are other than those which comprise a phosphorous atom directly substituted by a plurality of (e.g. two) hydroxy groups or by only one hydroxy group and only one hydrocarbyloxy group.

More preferred polymer precursors of the present invention are other than those represented by any of the following formulae:

I)

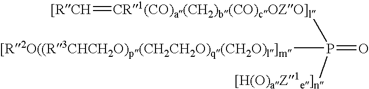

where R″═H, HO₂C; R″¹═H,Me,HO₂C; R″²═C₁₋₂₂hydrocarbon radical; R″³═Me,Et; Z″,Z″¹=alkylene; a″,b″,c″,d″,e″=0,1; a″+b″=0,1; b″+c″=0,1,2; a″+c″=2,1,0; 0<=p<=20; 0<=q″<=10; 0<=r″<=5; l″=1,2,3; m″,n″=0,1,2; and l″+m″+n″=3; or

II)

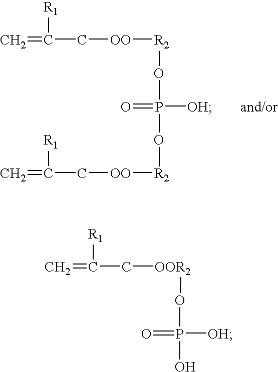

where in both cases independently R₁═H,Me; and R₂=lower (C₁₋₄)alkylene group; and/or

III)

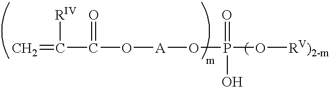

where R^{IV}═H or Me; A=divalent alcohol residue, R^{V}═H or C₁₋₄alkyl; and m=1 or 2.

Other aspects of the invention provide for any of 1) to 6) below:

1) use of at least one of the following polymer precursors to prepare optionally end capped urethane acrylates;

2) a method of making optionally end capped urethane acrylates by reacting at least one of the following polymer precursors;

3) optionally end capped urethane acrylates obtained and/or obtainable from at least one of the following polymer precursors;

4) use at least one of the following polymer precursors as flame retardants;

5) use of at least one of the following polymer precursors to prepare flame retardants; and/or

6) a method of making a flame retardant composition comprising reacting and/or incorporating into a composition at least one of the following polymer precursors;

where in each case the polymer precursors comprise a co-polymerisable phosphorus containing polymer precursor which comprises:

a) a polymerisable unsaturated bond,

b) an oxycarbonyl or iminocarbonyl group;

c) a free hydroxy group or a functional group obtainable by reaction of a free hydroxy group with a suitable electrophile; and

d) a terminal phosphorus and oxygen containing group located at the end of a carbon chain and comprising at least one group selected from: hydroxy phosphorus and an optionally substituted hydrocarbyl group attached to a phosphorus atom through an oxy group;

and where the polymer precursor is substantially free of halo comprising species.

Preferred polymer precursors used in the preceding aspects of the present invention comprise those having a molecular weight (Mₙ if a polymer) of from about 200 to about 5,000 daltons; and a viscosity of less than about 14,000 mpa.s.

Optional features of the polymer precursors of the present invention (which exclude the disclaimed compounds as described herein) and of the polymer precursors used in other aspects of the present invention such as 1) to 6) above (which in the broadest scope include the disclaimed compounds as described herein) are given below.

Preferably component b) is a divalent linking group between two non-H moieties (i.e. is other than a non terminal group substituted by H), more preferably is an oxycarbonyl group.

Preferably component b) is substituted directly on component a).

Preferably components a), b) and c) together comprise the same organo group (or part thereof), more preferably comprising the same carbon chain, which is directly substituted onto the phosphorus atom of component d).

Preferably the polymer precursor of and/or used in the invention has a molecular weight (Mₙ if a polymer) of from about 250 to about 4,000 daltons, more preferably from about 300 to about 3,000 daltons, most preferably from about 300 to about 2,000 daltons.

The viscosity values quoted herein are Hoppler viscosities measured at 25° C. Preferably the polymer precursors of the invention have a viscosity of from about 20 to about 12,000 mPa.s,. more preferably from about 30 to about 7,000 mPa.s, most preferably from about 50 to about 5000 mPa.s.

In one option of the invention polymer precursor(s) of the invention may be substantially free (preferably 95% free by weight) of unreacted P—OH groups

The phosphorus-containing polymer precursors of the invention can be copolymerised by any suitable means of copolymerisation well known to those skilled in the art. Examples of suitable methods comprise: thermal initiation; chemical initiation by adding suitable agents; catalysis; and/or initiation using an optional initiator followed by irradiation, for example with electromagnetic radiation (photo-chemical initiation) at a suitable wavelength such as UV; and/or with other types of radiation such as electron beams, alpha particles, neutrons and/or other particles.

Polymer precursors of the invention may comprise one or more monomer, oligomer, polymer and/or mixtures thereof which have suitable polymerisable functionality. A monomer is a substantially monodisperse compound typically with a low molecular weight (e.g. <1000 g/mol). A polydisperse mixture of compounds prepared by a polymerisation method is a polymer. An optionally polydisperse compound of intermediate molecular weight, higher than a monomer can be considered an oligomer. In fact, in the context of the polymer precursors of the invention the term polymer is synonymous with oligomer. The polymer precursor of and/or used in the invention may be prepared by direct synthesis or (if the polymeric precursor is itself polymeric) by polymerisation. If a polymerisable polymer is itself used as a polymer precursor of and/or used in the invention it is preferred that such a polymer precursor has a low polydispersity, more preferably is substantially monodisperse, to minimise the side reactions, number of by-products and/or polydispersity in any polymeric material formed from this polymer precursor.

Preferably the polymerisable unsaturated bond “a” comprises an alkylidene double bond such as a vinyl group, or an allyl group, more preferably is an unsaturated bond activated for nucleophilic attack, for example by being positioned suitably near to an electron withdrawing group in the polymer precursor. For example the double bond “a” may be in the α position with respect to a carboxy or amido group (such as group “b”) to form an alkylacrylate or acrylamide group and may be optionally conjugated with such a group.

Preferably the group “b” comprises carboxy or amido groups. More preferably group “b” comprises a C₁₋₁₈hydrocarbylcarboxyalkylacrylate moiety. Most preferably group “b” is a ethylenecarbonyl group optionally substituted by one or more optionally substituted C₁₋₈alkyl groups. Group “b” may be, for example, ethylenecarbonyl(meth)acrylate.

Preferably the group “c” may be a free hydroxy group., in which case the polymer precursor can undergo an optional reaction before polymerisation to introduce other functionalities into the polymer precursor and hence other properties to the final polymer. For example the polymer precursor can chemically react through the free hydroxy group with a suitable group [for example an isocyanate group and/or a N-methylol group (such as N-methylolacrylamide)] to form as product another (still co-polymerisable) polymer precursor in which the polymerisable unsaturated bond “a” has remained intact. Thus afterwards this functionalised polymer precursor product can still be copolymerised by reacting through the unreacted double bond with other monomers or polymer precursors to form a polymer.

Preferably the terminal phosphorus and oxygen containing group “d” is an oxyphosphorus group i.e. comprises at least one carbon to oxygen to phosphorus bond (i.e. “C—O—P”). More preferably the terminal group “d” comprises at least one terminal phosphorus to oxygen bond (for example a “—P═O” and/or a “—P—O” bond). Most preferably in the terminal group “d” the group or groups that are attached directly to the phosphorus atom are selected from other than aryl and/or alkyl. Most preferably the terminal group “d” comprises at least one terminal phosphate ester group and/or terminal phosphonate ester group.

As used herein the term “terminal phosphate ester group” denotes, independently in each case, a group of formula ——OPO(OR¹)(OR²) where R¹ and R² each independently represent an optionally substituted hydrocarbyl radical, preferably optionally substituted C₁₋₁₆hydrocarbyl, (such as an aliphatic, cycloaliphatic or aromatic radical). Analogously the term “phosphate ester” denotes a compound of formula “HOPO(OR¹)(OR²)”.

As used herein the term “terminal phosphonate ester group” denotes, independently in each case, a group of formula “—PO(OR³)(OR⁴)” where R³ and R⁴ each independently represent an optionally substituted hydrocarbyl radical, preferably optionally substituted C₁₁₋₆hydrocarbyl, (such as an aliphatic, cycloaliphatic or aromatic radical). Analogously the term “H-phosphonate ester” denotes a compound of formula “HPO(OR³)(OR⁴)”.

The polymer precursors of and/or used in the invention are substantially free of halo species such as halogen radicals or halide ions. Preferably the polymer precursor is 95% halo free by weight, more preferably 99% fr e by weight of halo species either as functional groups or impurities. The term ‘halo’ as used herein signifies fluoro, chloro, bromo and iodo; preferably chloro and bromo.

To avoid side reactions and the formation of many different isomers which then have to be isolated and separated before polymerisation; preferably the polymer precursor comprises only one unsaturated bond which is capable of being polymerised (i.e. reacting under the conditions of polymerisation). Thus it is preferred that in a polymer prepared using a polymer precursor of and/or used in the invention, a single repeat unit of a unique structure is derived from said polymer precursor. Of course if polymerisation occurs in the presence of other polymer precursor(s) (not of the present invention, which optionally may also contain phosphorus) then a polymer formed from a preferred polymer precursor of and/or used in the invention (having only one polymerisable unsaturated bond) may be a copolymer which contains at least two different repeat units, the other repeat unit(s) being derived from the other polymer precursor(s).

Optionally the polymer precursor of and/or used in the invention has use as a flame retardant either itself or when incorporated into a polymer during a co-polymerisation process.

Conveniently the co-polymerisable phosphorus containing polymer precursor of the present invention comprises a compound of Formula 1.

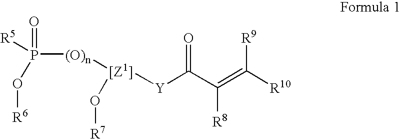

in which:

the polymerisable unsaturated bond is represented by the moiety ♭—C(R⁸)═CR⁹R^{10”}

the oxycarbonyl or iminocarbony group is represented by the moiety “—Y(C═O)—”;

the free hydroxy group or a functional group obtainable by reaction of a free hydroxy group with a suitable electrophile is represented by the moiety “—OR⁷”; and

the terminal group comprising phosphorus and oxygen is represented by the moiety of Formula A:

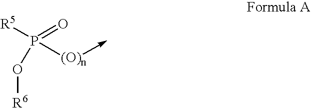

and where in Formula 1:

n is 0 or 1 (i.e. when n is 0 the P atom is directly attached to the [Z¹] moiety);

Y represents oxy or optionally substituted imino,

[Z¹] independently represents a multivalent (for example tri- or tetra-valent) organic linking moiety (which may be an atom or group such as any suitable organo group) connecting the moieties of Formula A; “—Y(C═O)—”; and “—OR⁷”;

R⁵ represents H or an optionally substituted C₁₋₃₀organo group;

R⁵ represents H or an optionally substituted C₁₋₃₀hydrocarbonyl;

R⁷, R⁸, R⁹ and R¹⁰ independently represent H and/or an optionally substituted C₁₋₃₀organo group;

with the proviso that

when: n is 1; R⁵ is C₁₋₂₄alkoxy, C₆₋₂₀(alk)aryloxy or C₇₋₁₂aralkoxy; R⁶ is H, C₁₋₂₄alkyl, C₆₋₂₀(alk)aryl, or C₇₋₁₂aralkyl; R⁷ is H; Z¹ is —CH₂(CH—)CH₂—; Y is oxy; R⁸ is H or methyl, and R⁹ is H; then R¹⁰ is other than H.

Conveniently the co-polymerisable phosphorus containing polymer precursor used in other aspects of the present invention (such as those described in aspects 1 to 6 above) comprises a compound of Formula 1A

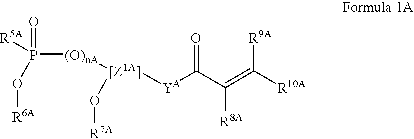

in which:

the polymerisable unsaturated bond is represented by the moiety “—C(R^{8A})═CR^{9A}R^{10A”}

the oxycarbonyl or iminocarbony group is represented by the moiety “—Y^{A}(C═O)—”;

the free hydroxy group or a functional group obtainable by reaction of a free hydroxy group with a suitable electrophile is represented by the moiety “—OR^{7A}”; and

the terminal group comprising phosphorus and oxygen is represented by the moiety of Formula AA:

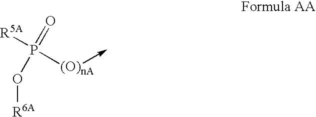

and where in Formula 1A:

“n^{A”} is 0 or 1 (i.e. when n^{A} is 0 the P atom is directly attached to the [Z^{1A}] moiety);

Y^{A} represents oxy or optionally substituted imino,

[Z^{1A}] independently represents a multiivalent (for example tri- or tetra-valent) organic linking moiety (which may be an atom or group such as any suitable organo group) connecting the moieties of Formula M; “—Y^{A}(C═O)—”; and “—OR^{7A}”;

R^{5A} represents H or an optionally substituted C₁₋₃₀organo group;

R^{6A} represents H or an optionally substituted C₁₋₃₀hydrocarbyl;

R^{7A}, R^{8A}, R^{9A} and R^{10A} independently represent H and/or an optionally substituted C₁₋₃₀organo group.

Formula 1A is used herein to represent Formula 1 without any provisos thereto. It will be understood that hereinafter (and in the claims) that integers and/or moie(ties) used in Formula 1 herein such as those denoted by n, Y, Z¹ and/or R⁵ to R¹⁰ (and for example also used in other formulae herein) may also represent the options for the corresponding integer(s) and/or moiet(ies) represented similarly in Formulae 1A and AA herein with an ‘A’ suffix such as those denoted by n^{A}, Y^{A}, Z^{1A} and/or R^{5A} to R^{10A} herein.

Optional features of Formulae 1 and 1A are given below.

More conveniently Y is —O—, —N(H)— or —N(C₁₋₁₀alkyl)-.

More conveniently when R⁵ is selected from OH, C₁₋₂₄alkoxy, C₆₋₂₀(alk)aryloxy, or C₇₋₁₂aralkoxy, then n is 0.

Usefully R⁵ is selected from at least one of the group consisting of: optionally substituted C₁₋₁₈hydrocarbyl and optionally substituted C₁₋₁₈hydrocarbyloxy; most usefully C₁₋₁₂alkyl and C₁₋₁₂alkoxy.

Usefully R⁶ is optionally substituted C₁₋₁₈hydrocarbyl, more usefully C₁₋₁₂alkyl.

Usefully [Z] is selected from the group consisting of: an optionally substituted C₁₋₂₄organo group; more usefully optionally substituted C₁₋₁₈hydrocarbyl and optionally substituted C₁₋₁₂hydrocarbyloxycarbonyC₁₋₁₂hydrocarbyl; for example C₁₋₁₂alkyl and C₁₋₁₂alkylcarboxyC₁₋₁₂alkyl.

Usefully R⁷ is selected from the group consisting of: H and optionally substituted C₁₋₁₈organo group, and more usefully H and C₁₋₁₂hydrocarbyl. For example R⁷ may be H or C₁₋₈alkyl.

Usefully R⁸, R⁹ and R¹⁰ are independently selected from at least one of the group consisting of: H and optionally substituted C₁₋₁₂hydrocarbyl; more usefully and C₁₋₈alkyl. For example R⁹ and R¹⁰ may both be H and R⁸ may be H or methyl.

A preferred aspect of this invention relates to copolymerisable compounds based on phosphorus-containing unsaturated polymerisable compounds such as alkylacrylates. These phosphorus-containing monomers have a high phosphorus content and can be used in the applications or uses described herein for example to confer flame retardancy properties to polymers.

Preferred polymer precursors of and/or used in the present invention exhibit a low viscosity and therefore may be used as diluents in a copolymerisation process, for example as diluting monomer(s) in radiation curable polymer chemistry. Such polymer precursors exhibit a sufficiently high phosphorus content so if they are used as diluting monomers, the phosphorus-content of the resulting polymer is quite high. Polymer precursors of and/or used in the invention are thus particularly useful to prepare compounds, polymers and/or compositions with properties (and/or to impart themselves such properties) useful in at least one of the following applications: anti-corrosion, pigmentary dispersion; adhesion promotion and/or flame retardancy, especially flame retardancy.

The polymer precursors of and/or used in the invention (optionally functionalised via reaction of the free hydroxy group “c” as described above to form groups linked to the rest of the molecule for example through a oxy bond) can be copolymerised by reacting through the unreacted double bond with other monomers or polymer precursors to form a polymer. For example, these co-polymerisable compounds can be incorporated into polyurethanes through urethane bond formation. The halogen-free, co-polymerisable polymer precursors of the invention can be modified in a wide variety of different ways to optimise the properties of the final polymer.

Compositions comprising the polymer precursors of the invention can be cured in a very convenient way [e.g. by radiation (UV, EB) or thermal curing (with thermal initiators)] to generate a cross-linked network of polymer chains in situ which form a coating and/or film of resin (such as polyurethane) which is flame-retardant.

Preferably polymeric compositions of the invention comprise polymers of the invention such as the oligomers described herein diluted with-polymer precursors of the invention such as the monomers described herein and such compositions may have a viscosity from about 400 to about 12,000 mpa.s, most preferably from about 5000 to about 10,000 mPa.s.

In a further aspect, the present invention comprises a process for preparing a substantially halo free phosphorus-containing (co)polymerisible polymer precursor comprising:

a) a polymerisable unsaturated bond,

b) a oxycarbonyl or iminocarbonyl group;

c) a free hydroxy group or a functional group obtainable by reaction of a free hydroxy group with a suitable electrophile; and

d) a terminal phosphorus and oxygen containing group located at the end of a carbon chain and comprising at least one group selected from: hydroxy phosphorus and an optionally substituted hydrocarbyl group attached to a phosphorus atom through an oxy group;

the process comprising the step of reacting

(i) a compound comprising at least one oxirane group and at least one optionally substituted alkylidenecarboxy group; with

(ii) a compound comprising at least one terminal phosphorus and oxygen containing group located at the end of a carbon chain and comprising at least one group selected from:

hydroxy phosphorus and an optionally substituted hydrocarbyl group attached to a phosphorus atom through an oxy group.

Preferably all the reagents, (and if required any optional solvents, catalysts and/or other materials) used in the process of the invention are substantially free of halo comprising species (per se and/or as impurities) so that the polymer precursor obtained is also substantially free of halo comprising species, without any further purification steps being required.

Preferred aspects of components a) to d) in the process of the invention are those given herein for the polymer precursors of and/or used in the invention.

Preferably the process of the invention is solvent free, only the reagents being used. More preferably in the process of the present invention the polymer precursor of and/or used in the invention is obtained directly without any work up step(s) other than optionally one or more, preferably one; filtration step(s).

Preferably the process conditions are such that the final polymer precursor obtained is substantially free of unreacted P—OH groups.

The term oxirane denotes an optionally substituted, saturated ring of up to eight, more preferably from 3 to 6 atoms, in which an oxygen atom is one of the ring atoms, the other ring atoms being carbon. More preferred oxiranes comprise optionally substituted three (epoxy) or four (oxetanyl) membered rings.

Although generally it is preferred that the polymer precursors of and/or used in the invention do not comprise any unreacted P—OH groups, in a particular aspect of the process of the invention the phosphorus compound can comprise phosphoric acid (H₃PO₄) or a monosubstituted phosphoric acid ester used in a stoichiometric equivalent amount to the number of oxirane radicals in the corresponding oxirane or polyoxirane. Thus for example if a mono-epoxide is used, one equivalent of phosphoric acid or one equivalent of a monosubstituted phosphoric acid ester are used and the resultant product comprising one terminal phosphoric acid mono or di-ester group which comprises free P—OH groups. Such mono- or di-substituted phosphoric acid esters and salts thereof (e.g. sodium salts) which also form another aspect of the invention can be used as polymer precursor(s) to prepare (co)polymers, for example by incorporation into an urethane acrylate like the compounds comprising terminal phosphate or phosphonate ester groups described herein. Such polymers are flame retardant (due to the phosphorus) and have good adhesion properties to substrates (e.g. metal substrates) due to the free hydroxy groups along the polymer backbone and the free P—OH groups can be neutralised to get water soluble polymers.

More preferably in the process of the present invention compound (i) comprises a compound of Formula 2:

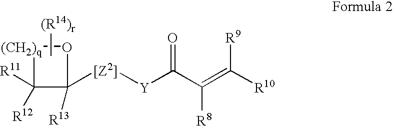

in which,

q represents 0 or an integer from 1 to 3, most preferably 0 or 1, for example 0;

r represents 0, or if q is other than 0, an integer from 1 to q;

Y represents NMe, NH or O;

R⁸, R⁹, R¹⁰ are independently as described herein;

R¹¹, R¹², R¹³ and R¹⁴ represent, independently in each case, H or an optionally substituted organo group, conveniently H or optionally substituted C₁₁₋₁₈organo group; more conveniently H or C₁₋₈hydrocarbyl; and

[Z²] represents an optionally substituted multivalent organic linking group, conveniently an optionally substituted tetra- tri- or divalent C₁₋₁₈organo group, more conveniently divalent C₁₋₈hydrocarbyl.

Conveniently the linking group [Z²] may comprise a one or more rings which are preferably saturated rings. Such rings may comprise one or more used and/or spiro rings. As well as being linked directly to the oxiranyl ring as shown in Formula 2, [Z²] may in addition also be linked to one or more of the groups R¹¹, R¹², R¹³ and/or R¹⁴ to form (optionally together with the atoms to which they are attached) one or more other rings.

Advantageously in Formula 2:

q is 0 or 1;

r is 0;

Y is 0 or NH;

R⁸ is H or C₁₋₄alkyl;

R⁹, R¹⁰, R¹¹, R¹² and R¹³ are each independently H or methyl, and/or

[Z²] is C₁₋₂₀alkylene.

Advantageously when q is 0, r is 0, and R¹¹ and R¹³ are both H; then [Z²], R¹² and the oxiranyl group to which they are both attached represent a group selected from:

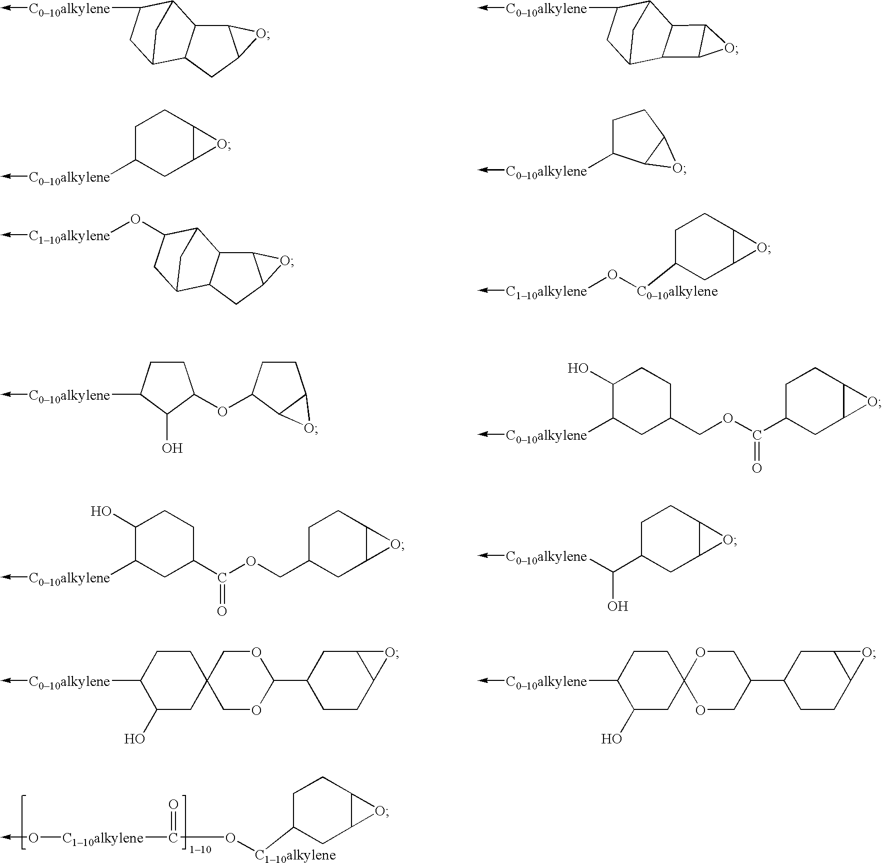

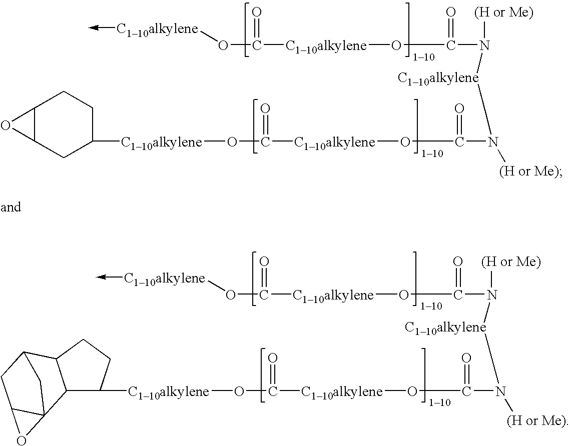

Most preferably compound (i) comprises an optionally substituted epoxy C₁₋₁₈hydrocarbyloxycarbonylethylene(C₁₋₁₈hydrocarbyl); most preferably a 2,3-epoxyC₁₋₁₈alkoxycarbonylethylene(C₁₋₈akyl), for example glycidylacrylate and/or glycidylmethacrylate (referred to herein as GMA). As used herein the term “glycidyl” denotes the group “2,3-epoxypropyl”.

Some other specific examples of epoxides useful as compound (i) include:

glycidyl acrylate;

glycidyl methacrylate;

beta-methylglyicidyl acrylate;

beta-methylglycidyl methacrylate;

bisphenol A monoglycidyl ether methacrylate;

4-glycidyloxybutyl methacrylate;

3-(glycidyl-2-oxyethoxy)-2-hydroxypropyl methacrylate;

3-(glycidyloxy-1-isopropyloxy)-2-hydroxypropyl acrylate;

3-(glycidyloxy-2-hydroxypropyloxy)-2-hydroxypropyl acrylate;

bisphenol A type epoxy acrylates (also referred to herein as EA):

tripropylene glycol diacrylate (also referred to herein as TPGDA);

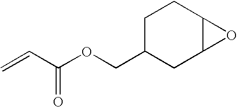

(available commercially from Daicel Chemical Industries Ltd. under the trade name Cyclomer A200); and/or

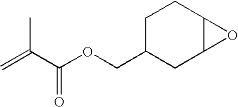

(available commercially from Daicel Chemical Industries Ltd. under the trade name Cyclomer M100).

Other examples of compound (i) comprise 3,4-epoxycyclohexylmethyl-3,4-epoxycyclohexane carboxylates in which each of the carbon atoms or alphatic carbon rings optionally substituted, preferably by one or two substituents, more preferably by C₁₋₁₂hydrocarbyl most preferably by C₁₋₉(linear)alkyl.

Some other specific examples of carboxylates useful as compound (i) include:

3,4-epoxycyclohexylmethyl-3,4-epoxycyclohexane carboxylate;

3,4-epoxy-1-methylcyclohexylmethyl-3,4-epoxy-1-methylcyclohexane carboxylate;

6-methyl-1-(3,4-oxycyclohexyl)methyl-6-methyl-3,4-epoxycyclohexane carboxylate;

3,4-epoxy-3-methylcyclohexylmethyl-3,4-epoxy-3-methylcyclohexane carboxylate; and

3,4-epoxy-5-methylcyclohexylmethyl-3,4-epoxy-5-methylcyclohexane carboxylate.

In a first more preferable option the phosphorus containing compound (ii) comprises a phosphate ester, for example a dialkyl phosphate ester or diarylphosphate ester. Most preferably the free P—OH group on the phosphate ester attacks (for example nucleophilically) the oxirane group (for example 2,3-epoxide) of compound (i) in preference to the for example an alkylidene group of compound (i) to form a polymer precursor of and/or used in the invention comprising a terminal phosphate ester group. Advantageously this first option comprises a one step reaction which produces a polymer precursor of and/or used in the invention directly without any solvent and/or catalyst and/or without further isolation and/or purification steps being required.

In a second more preferable option the phosphorus containing compound (ii) comprises an H-phosphonate ester, for example a dialkyl phosphonate ester or diaryl phosphonate ester. Most preferably the H-phosphonate ester attacks (for example by Michael addition) the alkylidene group of compound (i) in preference to the oxirane group to form an intermediate compound (iii) comprising an oxirane group, a carboxy group and a terminal H-phosphonate ester. In a second step the oxirane group on this intermediate compound (iii) can then be reacted with a suitable reagent preferably an ad unsaturated carboxylic acid (such as acrylic acid) to form a polymer precursor of and/or used in the invention comprising a terminal H-phosphonate ester group. Advantageously this second option comprises a two step reaction to produces a polymer precursor of and/or used in the invention directly without any solvent and/or without any filtration steps being required and/or where the first step may be catalysed inexpensively by for example basic catalysts such as sodium methoxide and/or inorganic oxides such as calcium oxide.

The preceding reaction(s) can produce monomers in excellent yield and such monomers have a high phosphorus content by weight. A further aspect of the invention comprises any phosphorus-containing polymer precursor obtained by and/or obtainable from the process(es) of the present invention described above.

The process of the present invention has several important advantages compared to known methods of preparing phosphorus monomers and these advantages may include one or more of the following:

very short synthetic scheme, either a one or two-step procedure;

excellent yields (very few side reactions, so purification is unnecessary);

either no catalyst needed or recovery and reuse of catalyst in the first step is feasible;

reduced use of solvent (either not at all or none in the first step);

no work-up, i.e. no washing, no phase separation and/or no distillation so the materials can be prepared in a standard industrial plant at atmospheric pressure;

low viscosity of the end product;

economical, cheap and non-toxic starting materials which are available in industrial quantities;

environmentally friendly procedure (e.g. no use of halogenated compounds or production of halogenated side products which is often the case in phosphorus chemistry using the Arbuzov procedure);

easy process to scale-up for industrial production;

a reaction which can be easily monitored by following the decrease of the epoxy value;

a product which is substantially halogen-free with a high phosphorus-content and with good flame retardant properties (high oxygen index);

less corrosive combustion products than those generated by the combustion of known halogen-containing materials; and/or

(for certain materials of the invention) better hydrolysis resistance of phosphonate ester groups compared to phosphate ester groups.

Optionally the invention provides materials in which properties in the applications and/or uses achievable proportionally large phosphorus content. Optionally polymer precursors of the invention can be crosslinked for example by irradiation to produce compositions with properties useful in the applications and/or uses herein (such as flame retardancy). Compositions of the invention can be applied to any type of substrate, such as, in particular, wood, textiles, paper and plastics, such as polyethylene and polypropylene. Such compositions can produce a coating which exhibits useful properties (such as flame retardancy) with good resistance to external conditions.

In another aspect of the invention there is provided an organic compound or polymer comprising at least one optionally substituted cycloalkoxy group where at least one of the ring atoms is oxygen (more preferably C₃₋₆alkoxy; more preferably oxiranyl, most preferably epoxy and/or oxetanyl) in which the cycloalkoxy is linked to at least one optionally a-substituted alkylidenylcarbonyloxy group comprising at least one active hydrogen β to the carbonyl where:

a) at least one of the cycloalkoxy group(s) is capable of reacting with a phosphate ester to form a terminal phosphate ester group having a hydroxy on the β carbon atom; and/or

b) at least one alkylidenylcarbonyloxy group (optionally substituted on an adjacent carbon atom) is capable of reacting with an H-phosphonate ester to form a terminal phosphonate ester group beta to a carbonyloxy group and optionally at least one of the cycloalkoxy group(s) is capable of reacting with a carboxylic acid group conjugated with an unsaturated group (optionally an alkylidenyl group) to form a carbonyloxyhydroxyalkyl group adjacent an unsaturated carbon bond;

in either or both case such that the resultant product would comprise at least one phosphorus atom, at least one hydroxyl group and at least one polymerisable, unsaturated carbon bond.

Such compounds are capable of acting as compound (i) in a process of the present invention.

In a yet further aspect of the invention there is provided a process which comprises the steps of:

(a) reacting

(i) an organic compound or polymer comprising at least one optionally substituted cycloalkoxy group where at least one of the ring atoms is oxygen (preferably oxiranyl, more preferably C₃₋₆alkoxy; most preferably epoxy and/or oxetanyl) in which the cycloalkoxy is linked to at least one (optionally substituted on an adjacent carbon atom) alkylidenylcarbonyloxy group with:

(ii) one or more reactant(s) comprising, in the same or different reactant(s); and added either separately or together

(1) at least one phosphate ester which reacts with at least one of the cycloalkoxy group(s) of reactant (i) to form a terminal phosphate ester group with an hydroxy substituent on the adjacent carbon atom; and/or

(2) at least H-phosphonate ester which reacts with at least one of the alkylidenylcarbonyloxy group(s) of reactant (i) to form a terminal phosphonate ester group adjacent a carbonyloxy group;

(b) and then in an additional optional step adding a moiety comprising a carboxylic acid group conjugated with an unsaturated group (such as alkylidene) which reacts with at least one of any remaining cycloalkoxy group(s) in the product of step (a) to form a product comprising an carbonyloxyhydroxyalkyl group adjacent an unsaturated carbon bond;

in either or both case such that the resultant product comprises at least one phosphorus, at least one hydroxyl group and at least one polymerisable, unsaturated carbon bond.

The addition to the cycloakyl (preferably oxiranyl) group may or may not be performed under regioselective conditions so that the final product either comprises substantially one stereoisomer at that site and/or any mixtures thereof (e.g. racemate). If desired this can be achieved by suitable choice of catalyst, cycloalkyl and/or phosphorus and oxygen comprising moieties.

Preferably the unsaturated carboxylic acid used in optional step (b) of the process of the invention comprises a compound of Formula 3

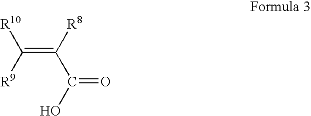

in which R⁸, R⁹ and R¹⁰ independently represent those groups as described herein. More preferably the unsaturated carboxylic acid comprises acrylic acid.

Preferably the phosphorus comprising reactant comprises a compound of Formula 4

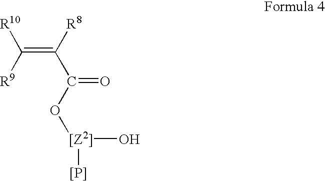

in which R⁸, R⁹, R¹⁰ and [Z²] are independently as described herein, and [P] denotes a terminal phosphate ester group or a terminal phosphonate ester group.

Preferably in the process of the present invention the phosphorus comprising reactant comprises either a terminal phosphate ester group or terminal phosphonate ester group but not both together. More preferably the optional step (b) is performed when the reactant in step (a) comprises a terminal phosphonate ester group.

Without wishing to be limited by any mechanism it is believed that the reaction of the H-phosphonate ester with the optionally alpha-substituted alkylidenylcarbonyloxy group is by a Michael addition.

In a yet further aspect the invention comprises a material obtained and/or obtainable from any of the processes of the present invention the material comprises at least one phosphorous, at least one hydroxy group and at least one polymerisable unsaturated carbon bond.

Preferably phosphorous containing material is selected from a compound of Formula 5

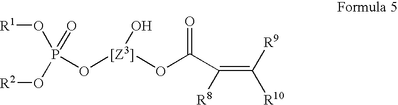

In which Z independently represents [Z¹] or [Z²] as described herein, and

R¹, R², R⁸, R⁹, R¹⁰ and R¹³ are independently as described herein, and/or a compound of Formula 6

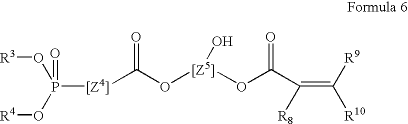

in which [Z⁴] and [Z⁵] both independently represent [Z¹] or [Z²] as described herein; and

R³, R⁴, R⁸, R⁹ and R¹⁰ are independently as described herein.

Conveniently compounds of Formulae 5 or 6 are those obtainable as described herein from the oxiranyl compounds of Formula 2 described herein.

More preferably in Formula 5:

R¹ and R² are independently C₁₋₄alkyl, most preferably n-butyl;

[Z³] and the OH attached thereto are —CH₂CH(OH)CH₂—; and/or

R⁸, R⁹ and R¹⁰ are independently H or C₁₋₄alkyl, most preferably H or methyl, for example R⁸ is Me and R⁹ and R¹⁰ are both H.

Some examples of more specific compounds of Formulae 5 comprise those represented by the following formulae:

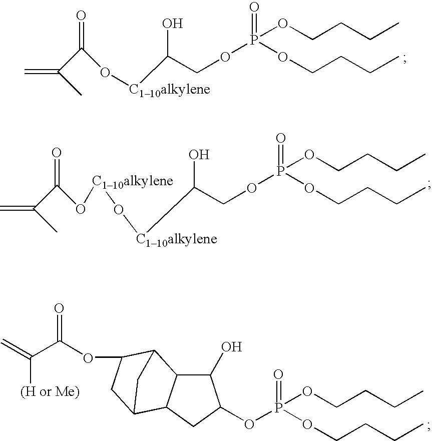

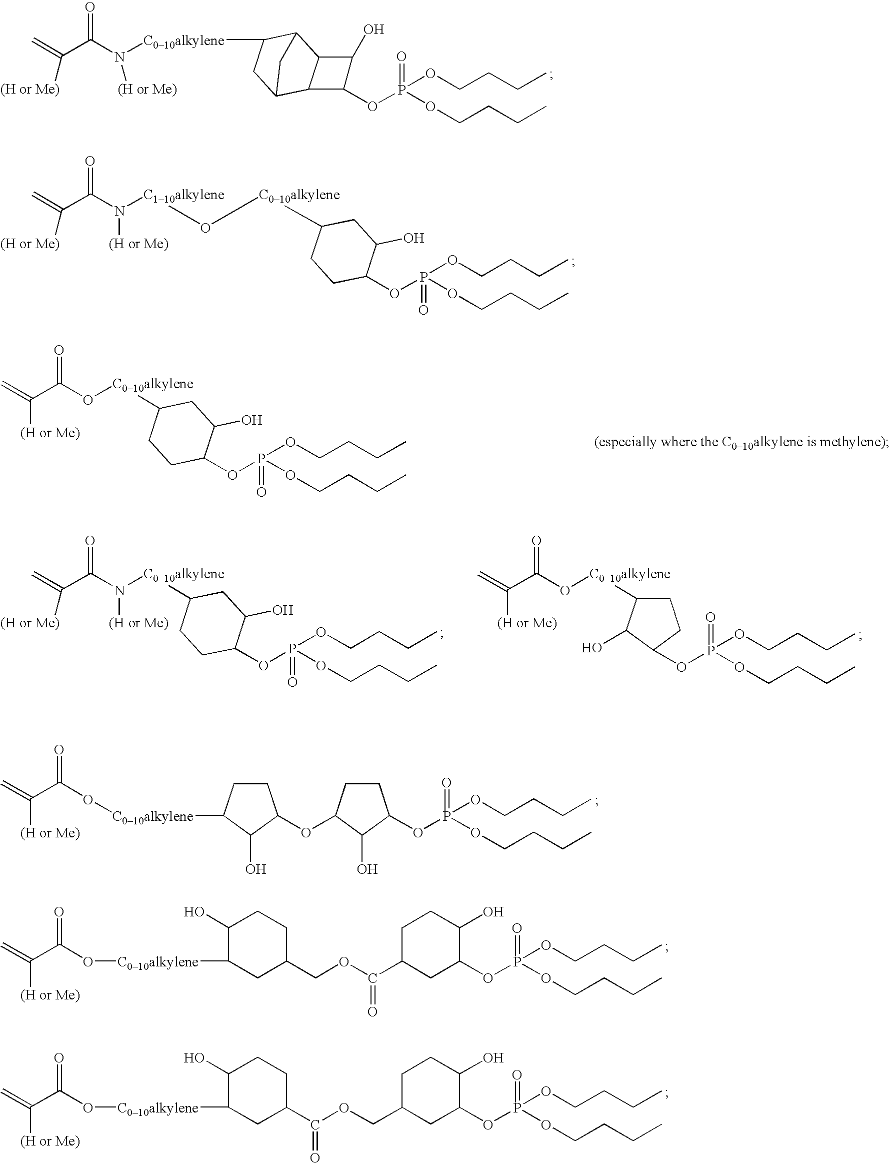

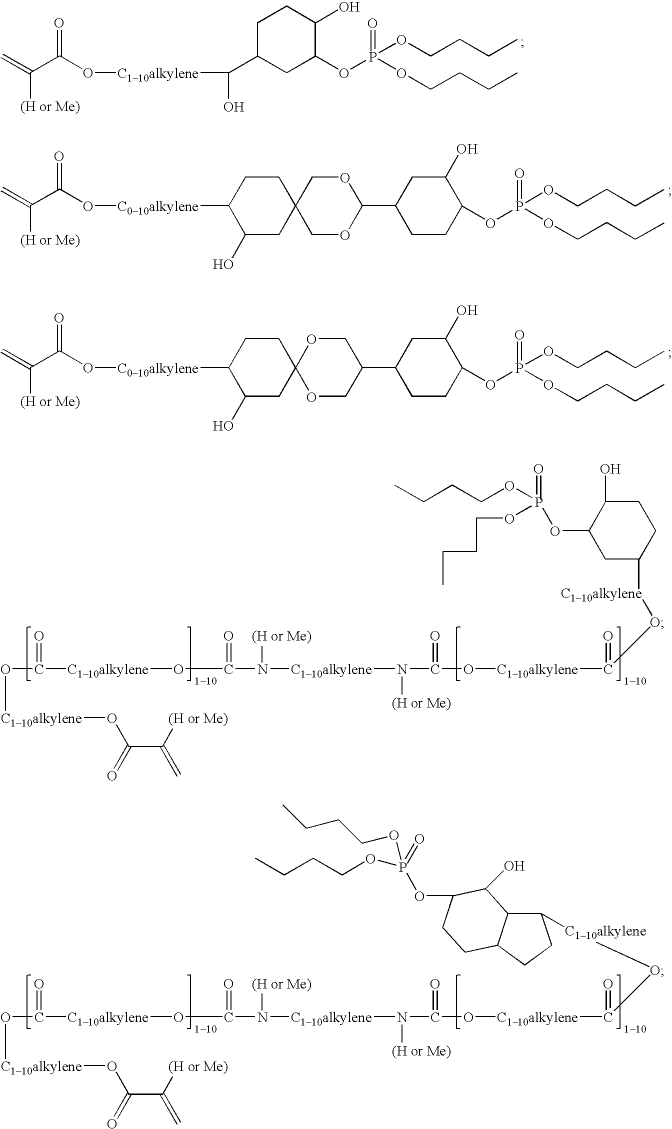

and all effective isomers thereof (for example analogous compounds formed from epoxides where the corresponding epoxy ring is opened from the other side and hence the phosphate ester group and OH group on adjacent carbon atoms in the above formulae swap places).

More preferably in Formula 6:

R³ and R⁴ are independently C₁₋₄alkyl, most preferably n-butyl;

[Z⁴] is C₁₋₁₀alkylene;

[Z⁵] and the OH attached thereto are —CH₂CH(OH)CH₂—; and/or

R⁸, R⁹ and R¹⁰ are independently H or C₁₋₄alkyl, most preferably H or methyl, for example R⁸ is Me and R⁹ and R¹⁰ are both H.

Some examples of more specific compounds of Formulae 6 comprise those represented by the following formulae:

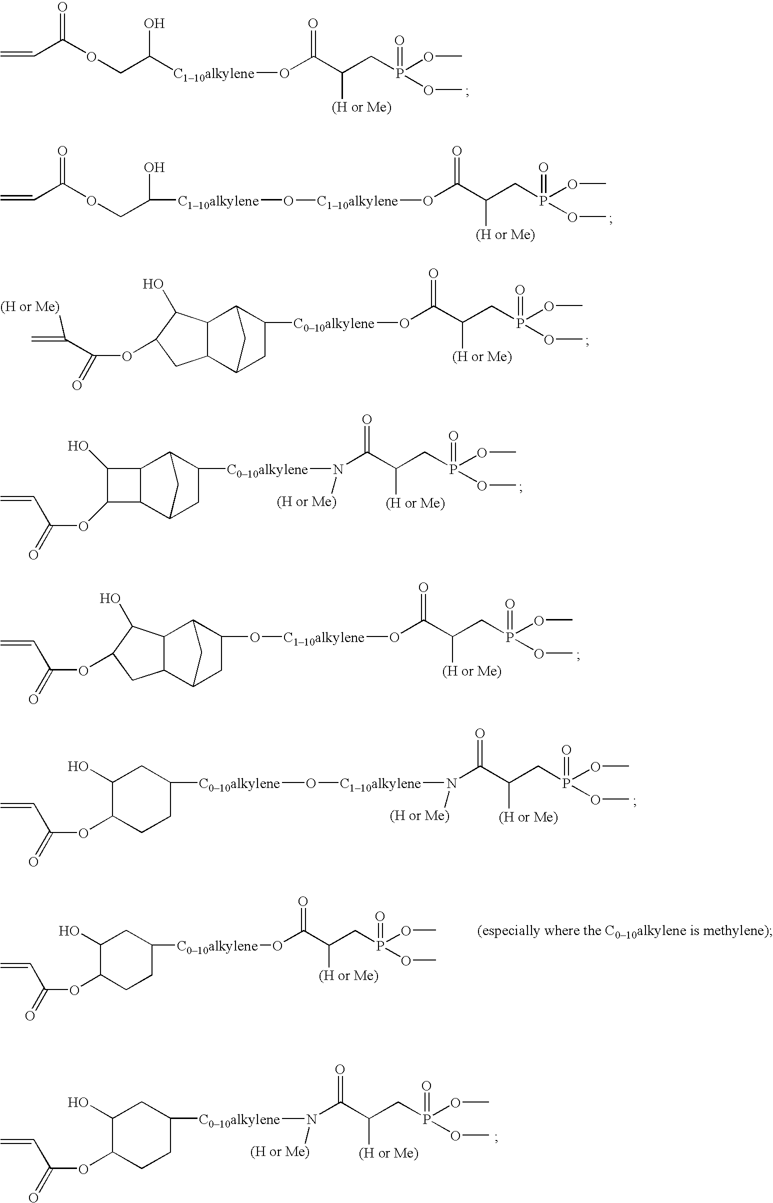

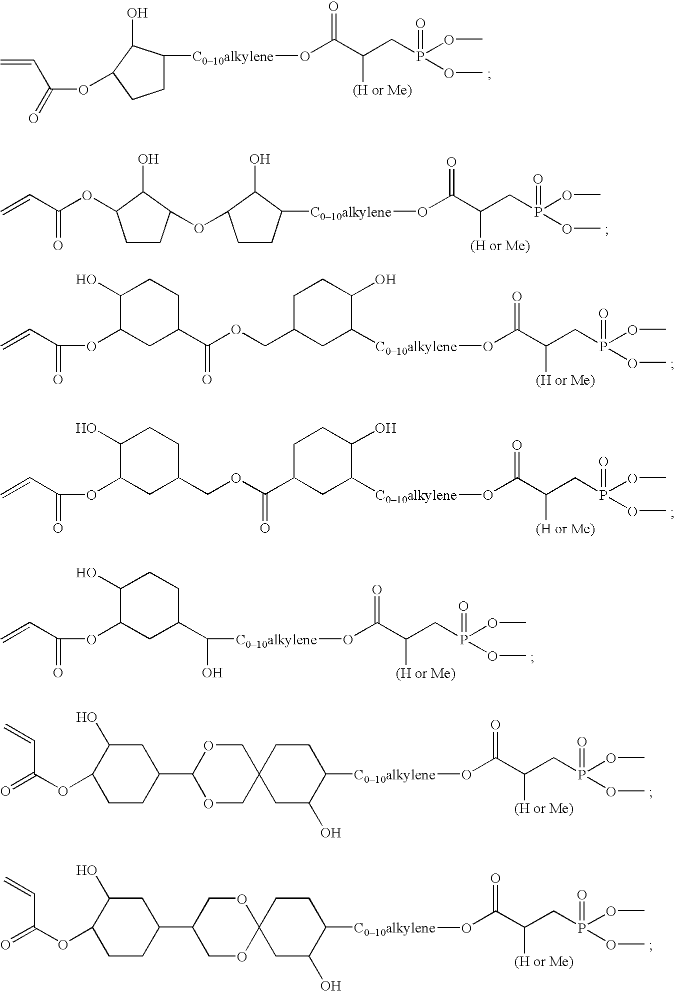

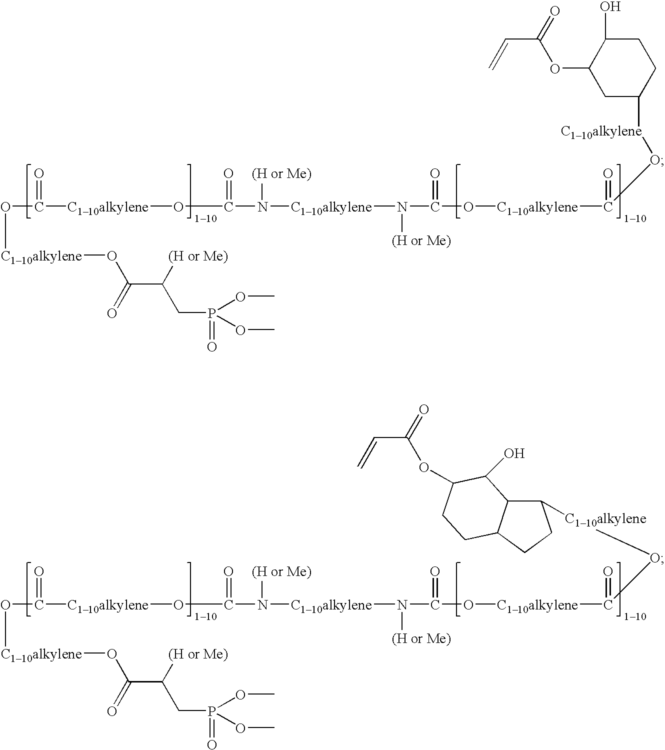

and/or all effective isomers thereof (for example analogous compounds formed from epoxides where the corresponding epoxy ring is opened from the other side and hence the phosphonate ester group and OH group on adjacent carbon atoms in the above formulae swap places).

A further aspect of the present invention comprises a polymerisation method for preparing a phosphorus containing polymer in which the method comprises a step of initiating polymerisation in the presence of a polymer precursor of and/or used in the present invention, which may for example be used as a reagent, co-monomer and/or end capper in combination with other ingredients such as (co)monomers, polymer precursors, catalysts, initiators, cross-linkers and/or other additives.

A still further aspect of the present invention is a phosphorus containing polymer obtainable from the polymerisation method of the present invention.

As used herein the term “end capper” refers to a reagent which is used during a polymerisation method to form a polymeric material, and which attaches to terminal groups located at the end of the growing polymer chains to cap the polymer chains and prevent further polymer growth. Thus an end capper can be used to control polymer molecular weight and also, as in this case, introduce specific functionality into the polymer chains.

More preferably the method of preparing a phosphorus containing polymer of the present invention comprises the steps of: reacting a diol with a di-isocyanate to form an oligomer (which is preferably terminated with an isocyanate group); and initiating polymerisation of this oligomer in the presence of a polymer precursor of and/or used in the present invention to form a phosphorus containing urethane polymer for example a urethane acrylate polymer.

Polymer precursors of the invention can replace an hydroxyalkylacrylate, such as a hydroxyethylacrylate (also denoted herein as HEA) and/or a hydroxyalkylmethacrylate, in a polymerisation process to end-cap polyurethanes and thus can be used to prepare improved effective (preferably flame retardant) polymers. It is convenient if phosphorus-containing polymer precursor(s) of the invention comprise at least one, preferably only one, hydroxyl group that can react with an isocyanate group. Such monomers can be used as end capping agents for the synthesis of radiation curable polyurethanes in which the copolymerisable moiety and phosphorus containing moiety are one and the same. This has several advantages over known methods for preparing urethane acrylates from phosphorus-containing polyols (such as described in WO 9502004 [DSM]), and such advantages may include one or more of those described herein.

For example once a polymer precursor of and/or used in the present invention has been prepared, it can be further reacted in situ with a polyisocyanate and/or another polyol (which optionally may also contain phosphorus) in the same reaction vessel for example using the well known Freeman method for the synthesis of so called “urethane (meth)acrylates”. As both conventional polyols (which do not containing any phosphorus) and/or other phosphorus containing polyols can be used in this reaction this allows one to prepare both a much broader range of phosphorus containing urethane (meth)acrylates and/or those with a particularly high phosphorus content. Examples of such reactions may comprise those described in the applicant's co-pending application PCT/EP00/01460, the contents of which are hereby incorporated by reference.

Polymer precursors of the present invention comprise a phosphorus moiety pendant to the main carbon chain, which thus is also pendant to the polymer backbone in a resultant polymer (such as obtained after cross-linking the polymer precursor by irradiation). This has the advantage of avoiding cleavage of the polymer chain during possible hydrolysis of the phosphorus containing group which minimises any impact on the physicochemical and mechanical properties of the phosphorus containing polymers of the invention.

Because one phosphorus atom is incorporated for each end capping of residual NCO, the phosphorus content of the resultant urethane acrylate polymer is high.

The terms ‘optional substituent’ and/or ‘optionally substituted’ as used herein (unless followed by a list of other substituents) signifies the one or more of following groups (or substitution by these groups): carboxy, sulpho, formyl, hydroxy, amino, imino, nitrilo, mercapto, cyano, nitro, methyl, methoxy and/or combinations thereof. These optional groups include all chemically possible combinations in the same moiety of a plurality (preferably two) of the aforementioned groups (e.g. amino and sulphonyl if directly attached to each other represent a sulphamoyl radical). Preferred optional substituents comprise: carboxy, sulpho, hydroxy, amino, mercapto, cyano, methyl and/or methoxy.

The terms ‘carbyl-derived’, ‘organic substituent’, “organic group” and/or “organo” (used herein and in the priority application to this application interchangeably and/or synonymously) denote any univalent or multivalent moiety (optionally attached to one or more other moieties) which comprises one or more carbon atoms and optionally one or more other heteroatoms. Organic groups may comprise organoheteryl groups (also known as organoelement groups) which comprise univalent groups containing carbon, which are thus organic, but which have their free valence at an atom other than carbon (for example organothio groups). Organic groups may alternatively or additionally comprise organyl groups which comprise any organic substituent group, regardless of functional type, having one free valence at a carbon atom. Organic groups may also comprise heterocyclic groups which comprise univalent groups formed by removing a hydrogen atom from any ring atom of a heterocyclic compound: (a cyclic compound having as ring members atoms of at least two different elements, in this case one being carbon). Preferably the non carbon atoms in an organic group herein may be selected from: hydrogen, phosphorus, nitrogen, oxygen and/or sulphur, more preferably from hydrogen,nitrogen, oxygen and/or phosphorous.

Most preferred organic groups comprise one or more of the following carbon containing moieties: alkyl, alkoxy, alkanoyl, carboxy, carbonyl, formyl and/or combinations thereof; optionally in combination with one or more of the following heteroatom containing moieties: oxy, thio, sulphinyl, sulphonyl, amino, imino, nitrilo and/or combinations thereof. Organic groups include all chemically possible combinations in the same moiety of a plurality (preferably two) of the aforementioned carbon containing and/or heteroatom moieties (eg. alkoxy and carbonyl if directly attached to each other represent an alkoxycarbonyl group).

The term ‘hydrocarbo group’ as used herein is a sub-set of a organic group and denotes any univalent or multivalent moiety (optionally attached to one or more other moieties) which consists of one or more hydrogen atoms and one or more carbon atoms and may comprise saturated, unsaturated and/or aromatic moieties. Hydrocarbo groups may comprise one or more of the following groups. Hydrocarbyl groups comprise univalent groups formed by removing a hydrogen atom from a hydrocarbon. Hydrocarbylene groups comprise divalent groups formed by removing two hydrogen atoms from a hydrocarbon the free valencies of which are not engaged in a double bond. Hydrocarbylidene groups comprise divalent groups (represented by “R₂C═”) formed by removing two hydrogen atoms from the same carbon atom of a hydrocarbon, the free valencies of which are engaged in a double bond. Hydrocarbylidyne groups comprise trivalent groups (represented by “RC≡”), formed by removing three hydrogen atoms from the same carbon atom of a hydrocarbon the free valencies of which are engaged in a triple bond. Hydrocarbo groups may also comprise saturated carbon to carbon single bonds; unsaturated double and/or triple carbon to carbon bonds (e.g. alkenyl, and/or alkynyl groups respectively) and/or aromatic groups (e.g. aryl) and where indicated may be substituted with other functional groups.

The term ‘alkyl’ or its equivalent (e.g. ‘alk’) as used herein may be readily replaced, where appropriate and unless the context clearly indicates otherwise, by terms encompassing any other hydrocarbo group such as those described herein (e.g. comprising double bonds, triple bonds, aromatic moieties (such as respectively alkenyl, alkynyl and/or aryl) and/or combinations thereof (e.g. aralkyl) as well as any multivalent hydrocarbo species linking two or more moieties (such as bivalent hydrocarbylene radicals e.g. alkylene).

Any radical group or moiety mentioned herein (e.g. as a substituent) may be a multivalent or a monovalent radical unless otherwise stated or the context clearly indicates otherwise (e.g. a bivalent hydrocarbylene moiety linking two other moieties). However where indicated herein such monovalent or multivalent groups may still also comprise optional substituents. A group which comprises a chain of three or more atoms signifies a group in which the chain wholly or in part may be linear, branched and/or form a ring (including spiro and/or fused rings). The total number of certain atoms is specified for certain substituents for example C_{1-N}organo, signifies a organo moiety comprising from 1 to N carbon atoms. In any of the formulae herein if one or more substituents are not indicated as attached to any particular atom in a moiety (e.g. on a particular position along a chain and/or ring) the substituent may replace any H and/or may be located at any available position on the moiety which is chemically suitable or effective.

Preferably any of the organo groups listed herein comprise from 1 to 36 carbon atoms, more preferably from 1 to 18. It is particularly preferred that the number of carbon atoms in an organo group is from 1 to 10, especially 1 to 4 inclusive.

The term “polyol” is understood to mean a compound or polymer which comprises at least two hydroxy groups not bound to the same carbon.

As used herein chemical terms (other than IUAPC names for specifically identified compounds) which comprise features which are given in parantheses—such as (alkyl)acrylate, (meth)acrylate and/or (co)polymer—denote that that part in parentheses is optional as the context dictates, so for example the term (meth)acrylate denotes both methacrylate and acrylate.

Unless the context clearly indicates otherwise, as used herein plural forms of the terms herein are to be construed as including the singular form and vice versa.

The term “comprising” as used herein will be understood to mean that the list following is non-exhaustive and may or may not include any other additional suitable items, for example one or more further feature(s), component(s), ingredient(s) and/or substituent(s) as appropriate.

The term ‘effective’ (for example with reference to the process, uses, products, materials, compounds, monomers, oligomers, polymer precursors and/or polymers of the present invention) will be understood to denote utility in any one or more of the following uses and/or applications: anti-corrosion, pigmentary dispersion; adhesion promotion and/or flame retardancy, preferably flame retardancy. Such utility may be direct where the material has the required properties for the aforementioned uses and/or indirect where the material has use as a synthetic intermediate and/or diagnostic tool in preparing materials of direct utility. Preferred uses are those which are necessary to provide improved protection and/or resistance to flame and/or a source of heat and/or ignition. When referring to the effective materials of the present invention it is preferred that the term ‘optionally substituted’ does not include halo containing species. As used herein the term “suitable” denotes that a functional group is compatible with producing an effective product.

The substituents on the repeating unit may be selected to improve the compatibility of the materials with the polymers and/or resins in which they may be formulated and/or incorporated to form a flame retardant material. Thus, the size and length of the substituents may be selected to optimise the physical entanglement or interlocation with the resin or they may or may not comprise other reactive entities capable of chemically reacting and/or cross-linking with such other resins.

Certain moieties, species, groups, repeat units, compounds, oligomers, polymers, materials, mixtures, compositions and/or formulations which comprise some or all of the invention as described herein may exist as one or more stereoisomers (such as enantiomers, diastereoisomers and/or geometric isomers) tautomers, conformers, salts, zwitterions, complexes (such as chelates, clathrates, interstitial compounds, ligand complexes, organometallic complexes, non-stoichiometric complexes, solvates and/or hydrates); isotopically substituted forms, polymeric configurations [such as homo or copolymers, random, graft or block polymers, linear or branched polymers (e.g. star and/or side branched), cross-linked and/or networked polymers, polymers obtainable from di and/or tri-valent repeat units, dendrimers, polymers of different tacticity (e.g. isotactic, syndiotactic or atactic polymers)]; polymorphs (such as interstitial forms, crystalline forms and/or amorphous forms), different phases, solid solutions; combinations thereof and/or mixtures thereof. The present invention comprises all such forms which are effective.

Advantageously one or more materials of the invention and mixtures thereof have utility in at least one of the following applications : anti-corrosion, pigmentary dispersion; adhesion promotion and/or flame retardancy, preferably flame retardancy. Therefore in a further aspect of the invention there is provided a material suitable for use in one or more of the preceding applications, preferably for use as a flame retardant, comprising one or more of the materials of the present invention as described herein; together with an effective carrier or diluent.

The materials of the invention may be formulated with a suitable resin substrate as a carrier or diluent. The resin may be selected to optimise any suitable property such as hardness or durability.

The polymers of the present invention may be prepared by one or more suitable polymer precursor(s) (including at least one polymer precursor of and/or used in the present invention) which may be organic and/or inorganic and comprise any suitable (co)monomer(s), (co)polymer(s) [including homopolymer(s)] and mixtures thereof which comprise moieties which are capable of forming a bond with the or each polymer precursor(s) to provide chain extension and/or cross-linking with another of the or each polymer precursor(s) via direct bond(s) as indicated in the Formulae herein. The polymer precursor(s) may be substantially un-reactive at normal temperatures and pressures. Polymerisation may be initiated by any suitable means which are well known to those skilled in the art for example: thermal initiation; chemical initiation by adding suitable agents; catalysis; and/or initiation using an optional initiator followed by irradiation, for example with electromagnetic radiation (photo chemical initiation) at a suitable wavelength such as UV; and/or with other types of radiation such as electron beams and/or alpha particles.

Preferably the phosphorus containing polymers of the present invention and/or obtained or obtainable by the processes and/or methods of the present invention is a urethane acrylate, for example urethane methacrylate. More preferably the method is a polymerisation method, most preferably one which uses radiation curing, for example with UV and/or electron beam radiation.

Isocyanates may be used as polymer precursors with the phosphorus containing polymer precursors of the present invention to form phosphorus containing polyurethane copolymers of the invention. Organic isocyanates which may be used to prepare such polyurethanes are preferably polyisocyanates (i.e. have two or more isocyanate groups per molecule), more preferably di-or tri- isocyanates. The isocyanates may be aliphatic, cycloaliphatic and/or aromatic. Some examples of suitable aliphatic di-isocyanates include: 1,4-di-isocyanatobutane; 1,6-di-isocyanatohexane; 1,6-di-isocyanato-2,2,4-trimethylhexane and 1,12-di-isocyanatododecane. Examples of suitable cycloaliphatic di-isocyanates include: 1,3- and 1,4-di-isocyanatocyclohexane; 2,4-di-isocyanato-1-methylcyclohexane; 1,3-di-isocyanato-2-methylcyclohexane; 1-isocyanato-2-(isocyanatomethyl)cyclopentane; 1,1-methylenebis[4-isocyanatocyclohexane], 1,1′-(1-methylethylidene) bis(4-isocyanato cyclohexane); 5-isocyanato-1-isocyanatomethyl-1,3,3trimethylcyclohexane (diisocyanate of isophorone); 1,3- and 1,4-bis(isocyanatomethyl)cyclohexane; 1,1-methylenebis [4-isocyanato-3-methylcyclohexane; and 1-isocyanato-4(or-3)-isocyanatomethyl-1-methyl cyclohexane. Examples of suitable aromatic di-isocyanates include: 1,4-di-isocyanatobenzene, 1,1-methylenebis[4-isocyanatobenzene]; 2,4-di-isocyanato-1-methylbenzene; 1,3-di-isocyanato-2-methylbenzene; 1,5--di-isocyanatonaphtalene; 1,1-(1-methylethylidene) bis[4-isocyanatobenzene], 1,3- and 1,4-bis(1-isocyanato-1-methylethyl)benzene. Some polyisocyanates aromatic or aliphatic polyisocyanates containing three isocyanate groups which are also suitable include for example: 1,1′,1″-tris[4-isocyanatophenyl]methane; the trimer of hexamethylenediisocyanate and polyisocyanates of polyphenyl polymethylene obtained by phosgenation of condensates of aniline and formaldehyde. The total quantity of organic (poly)isocyanates used to prepare preferred polyurethane polymers of the present invention may be from about 10 to about 60% by weight of the polyurethane.

More preferably the polymer of the present invention may comprise a polyurethane polymer represented by Formula 7:

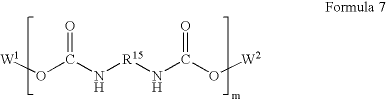

in which

m is from about 1 to about 100; and

R¹⁵ represents independently in each repeat unit, a suitable C₁₋₁₈organo linking group, conveniently C₁₋₁₂hydrocarbylene, more conveniently C₁₋₈alkylene;

W¹ and W² independently represent a phosphorus end capping group of Formula 8:

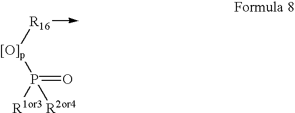

where R¹, R², R³ and R⁴ are independently as represented herein; and

p is 1 or 1;

R¹⁶ represents a C₁₋₁₈organo linking group which optionally comprises a polymerisable functionality, preferably a polymerisable double bond;

and where the polymer is substantially free both of halo species and of free P—OH groups; and has an average molecular weight of at least about 1000 daltons.

A polymer of the present invention (for example that of Formula 7) comprises terminal phosphate ester group(s) and/or terminal phosphonate ester group(s) which are attached in the polymer at the end of the polymer chains, to cap the polymer chains and prevent further polymer growth (i.e. act as end cappers) and also comprise a polymerisable functionality such as the double bonds shown in Formula 8.

Preferably the polymer of the invention has a polydispersity of at least about 1.1, more preferably from about 1.2 to about 4.0 and most preferably from about 1.5 to about 3.5.

Preferably the polymer of the invention has an average molecular weight (Mₙ) of from about 1,000 to about 20,000 daltons; more preferably from about 2,000 to about 15,000 daltons, most preferably 3,000 to about 10,000 daltons. In an alternative a polymer of the invention may have a Mₙ value of from about 1,000 to about 3,000 daltons. The Mₙ value may be measured by any suitable technique.

Preferably the polymers of the present invention comprise an average value for the number of repeat units per chain (denoted herein by “m”) of from about 2 to about 100, most preferably from about 2 to about 50. Preferably the polymers of the invention comprise a mixture of polymer chains with a substantially Gausian distribution of chain lengths.

Conveniently a further phosphorus resin of the present invention comprises those obtained or obtainable by further polymerisation of a polymer or polymer precursor as described herein (such as the phosphorus containing urethane acrylate polymers of Formula 7). Such phosphorus containing resins may be substantially cross-linked to form a network of linked polymer chains which may form for example a film or coating and contain one or more pendant phosphorus moieties within the polymer chain or network, for example a moiety of Formula 9:

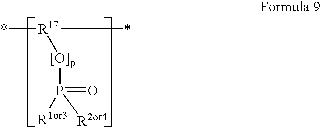

where R¹, R², R³, R⁴ and p are independently as described herein, and

R¹⁷ independently represents a multivalent C₁₋₁₈organo group;

together with one or more other suitable repeat units such as a urethane linkage.

The asterisks indicate that the repeat unit is multivalent, preferably divalent as shown in Formula 9.

In another aspect of the present invention there is provided a process for making an effective polymeric material; the process comprising: initiaiising pojymerisation between one or more polymer precursor(s) of the invention where the polymerisation is carried out in the presence of suitable amounts of a chain terminator.

Effective polymeric material obtainable by the aforementioned process also forms an aspect of the present invention. Such polymeric material comprises all the effective different forms of such material (and the polymer precursors for making it) as described above for the polymer with repeat unit show herein.

Preferably the polymer precursors of the invention have a phosphorus content of from about 1.0% to about 20.0%; more preferably from about 7.0% to about 15.0%; most preferably from about 8.0% to about 12.0% by mass of the polymeric precursor.

Preferably the polymers of the invention have a phosphorus content of from about 0.1% to about 10.0%; more preferably from about 1.0% to about 8.0%; most preferably from about 2.0% to about 5.0% by mass of the polymer.

It will be readily appreciated that a polymer of the present invention may tend to have a lower phosphorus content than a corresponding phosphorus containing polymer precursor of and/or used in the present invention after said polymer precursor has been diluted and incorporated in said polymer.

A still further aspect of the present invention comprises a phosphorus containing polymeric precursor obtained or obtainable by a process of the present invention as described herein and which comprises at least one phosphorus, at least one hydroxyl group and at least one non-polymerisable unsaturated bond.

In an even further aspect of the present invention comprises a polymer prepared by polymerising the polymer precursors of the present invention. Preferably such polymers are urethanes, for example polymers which comprise isocyanate linkages between some or all of the repeat units along the polymer backbone. More preferably the polymers are prepared by a polymerisation initiated by radiation, for example electron beam or UV radiation curing.

A yet further aspect of the present invention provides a first flame retardant product, component for said first product and/or consumable for use with said first product, which comprises at least one co-polymer precursor and/or polymer of the present invention, preferably as represented by Formula 1A herein.

Another aspect of the present invention provides use of a polymer precursor of and/or used in the invention, preferably as represented by Formula 1A herein, as a flame retardant and/or in the preparation of a flame retardant.

A yet still further aspect of the present invention provides a second product which has utility in one or more non-flame retardant applications and/or other uses (for example at least one of anti-corrosion, pigmentary dispersion and/or adhesion promotion); a component for said second product and/or a consumable for use with said second product, the second product comprises at least one co-polymerisable phosphorus containing polymer precursor and/or polymer obtainable from such a polymer precursor; in which the polymer precursor comprises:

a) a polymerisable unsaturated bond,

b) a oxycarbonyl or iminocarbony group;

c) a free hydroxy group or a functional group obtainable by reaction of a free hydroxy group with a suitable electrophile; and

d) a terminal phosphorus and oxygen containing group located at the end of a carbon chain.

Optionally the polymer precursors used to obtain the second product are substantially free of halo comprising species and/or have a molecular weight (Mₙ if a polymer) of from about 200 to about 5,000 daltons.

Another aspect of the invention provides use of at least one material of the present invention in the manufacture of an effective first or second product, component for said product(s) and/or consumable for use with said product(s).

Materials of the present invention may be used in combination with any other ingredient(s) conventionally used to formulate an effective (e.g. flame retardant) composition and/or product.

For example further flame retardant additives may be added to improve the flame retardant properties of the cured polymers herein with the advantage that they can be added at much lower loading to achieve a given flame retardant effect because the polymers of and/or used in the present invention already have flame retardant properties. As such additives (if used) will be present in lower amounts, this limits their corresponding drawbacks.

Examples of suitable flame retardant additives comprise one or more of the following and/or any compatible mixtures thereof:

phosphorous containing additives and/or effective isomers, salts and/or mixtures thereof, such as 9,10-dihydro-9-oxa-10-phosphaphenantrene-10-oxide (also referred to herein as “DOPO”); red phosphorous, ammonium phosphates; ammonium polyphosphates, melamine phosphates (e.g. melamine pyrophosphate and/or melamine orthophosphate), aliphatic organophosphorous additives (e.g. triethylphosphate, tributylphosphate, trioctylphosphate, triphenylphosphate and/or dimethyl methylphosphonate); oligomeric phosphorous compounds; trimethylolpropane methylphosphonate oligomer, pentaerythritol phosphates and/or polyphosphazene derivatives; inorganic hydroxides such as aluminium trihydroxide, magnesium hydroxide, brucite, hydromagnesite, aluminium phosphinates, mixed metal hydroxides and/or mixed metal hydroxycarbonates;

inorganic oxides such as magnesium oxide; and/or antimony trioxide;

silicone, silica and/or silicate derivatives; and/or

other inorganic materials such as magnesium calcium carbonate, barium metaborate; zinc borate, zinc hydroxystannate; zinc stannate; zinc metaborate; expandable graphite; and/or blends of vitreous materials that act as a flame retardant barrier (such as that available from Ceepree under the trade name Ceepree 200).

The flame retardant additives may optionally be surface treated to improve their compatibility with the polymers to which they are added. For example inorganic hydroxides may be surface treated with long chain carboxylic acid(s) and/or silane(s) as described in “Fire Retardancy of Polymeric Materials”, edited by Arthur F. Grand & Charles A. Wilkie; Marcel Dekker Inc (5000), pages 285 to 352.

Polymer precursors, polymers and/or first and/or second products, component for said product(s) and/or consumable for use with said product(s) of the invention may be used in any of the following applications flame retardancy, anti-corrosion, pigmentary dispersion and/or adhesion promotion.

Other aspects of and/or optional features of the present invention are described in the claims.

The present invention will now be illustrated by the following, non-limiting Examples, in which the following conventional techniques were used, well known to those skilled in the art: acid numbers were measured using American Standard method (ASTM) D 974-64; epoxy values were measured using ASTM E 200; hydroxy (OH) numbers were measured using ASTM E 222-73; NCO numbers were measured using ASTM D 2572-87; Hoppler viscosity (denoted herein by “H”) was measured at 25° C. using DIN 53015; colour was measured using the Gardner method as described in ASTM 1544-68; the Konig hardness (denoted herein by “K”) was measured using the method described in NFT 30-016, type 299; and phosphorus content was measured as the percentage mass of phosphorus atoms compared to the total mass of the compound, monomer, oligomer, polymer or composition as the context dictates (denoted herein by P% w/w).

### EXAMPLE 1

1a Preparation of phosphorus-containing methacrylate monomer

To a double jacketed one litre reaction vessel, connected to an oil bath and equipped with a stirrer was added 284 g of glycidyl methacrylate and 400 mg of methylhydroquinone. The reaction mixture was stirred and heated at 70° C. at atmospheric pressure. Then 420 g of dibutylphosphate were added at once. After observation of an exotherm (106° C.), the temperature was maintained at 70° C.; extra glycidylmethacrylate was added in little portions (total 31 g) to bring the acid number below 5 mg KOH/g and the epoxy value below 0.5%. The product obtained was a phosphorus-comprising methacrylate monomer with the following properties: OH number=159 mg KOH/g; acid number=4.5 mg KOH/g; epoxy value=0.10 meq/g; H=67 mPas, Gardner colour<1G; and P% w/w=8.4%.

1b Preparation of a Film Cured by Electron Beam (EB):

An amount of 42 g of the phosphorus-containing methacrylate monomer prepared as described in Example 1a above, was mixed with 50 g of an phosphorus free urethane acrylate (that available commercially from UCB S.A. under the trade name Ebecryl [EB] 284) and 8 g of trimethylolpropanetriacrylate (TMPTA) to form a formulation with P% (w/w)=3.5%. This formulation was applied to several substrates with a wire rod, and a 150 μm thickness film was prepared by curing the formulation with an electron beam at the following settings (reactivity 2 Mrad, EB curing 5 Mrad; 250 keV; substrate: inox plate). The film from Example 1b had the following properties: the number of double rubs of the film with acetone required to expose a paper substrate (acetone double rubs)>100; and K=57 s on a glass substrate. The film was tested further, as described in the results section below.

### EXAMPLE 2

2a Preparation of a phosphorus-containing urethane methacrylate oligomer

To a double jacketed two litre reaction vessel, connected to an oil bath equipped with a stirrer, was added 16 g of isophorone diisocyanate (IPDI), 264 g of the phosphorus-containing methacrylate monomer prepared as described in Example 1a, 250 mg of ditertiobutylhydroquinone (DtBHQ), and 250 mg of trinonylphenylphosphonate (TNPP). The reaction mixture was stirred and heated at 70° C. and atmospheric pressure. To this mixture was added 50 mg of dibutyl tin dilaurate (DBTL) and the temperature was maintained at 70° C. When the NCO value was below 1.74 meq/g, a mixture of 207 g of a polycaprolactone (that available commercially from Solvay Interox under the trade name CAPA 200 with an hydroxy number of 205 mg KOH/g) and 160 g of hexanedioldiacrylate (HDDA) was added to the reaction mixture using a dropping funnel over a 2 hour period. The temperature was then raised to 90° C. until the NCO value was less than 0.2%. The reaction mixture was then diluted with 87 g of HDDA, stabilized with 250 mg of DtBHQ and cooled at room temperature, to give as the product a urethane acrylate with following properties: H=3690 mPa.s; Gardner colour <1G; and P% w/w=2.5%.

2b Preparation of Film

In a manner analogous to that described in Example 1b (in which Example 1a was replaced by Example 2a) a 150 μm thickness film was obtained, which was tested as described in the results section.

### EXAMPLE 3

3a Preparation of phosphorus-containing methacrylate monomer

To a double jacketed one litre reaction vessel, connected to an oil bath and equipped with a stirrer, were added 310 g of a methacrylated aliphatic cycloepoxide (that available commercially from the Daicel company under the trade name Cyclomer M100) and 400 mg of hydroquinone. The mixture was heated to 50° C. at atmospheric pressure. Then were added at once 210 9 of dibutylphosphate. After observation of an exotherm (95° C.), the reaction mixture was maintained at a temperature of 80° C. whilst being stirred. Extra dibutylphosphate was added in small portions (100 g) during the reaction in order to decrease the acid value to less than 5 mg KOH/g and to decrease the epoxy value to less than 0.5%, to obtain as product a phosphorus-containing cycloaliphatic methacrylate with the following properties: OH number=120 mg KOH/g; acid number=1.70 mg KOH/g; epoxy value=0.15 meq/g; H=420 mPa.s, Gardner colour<3G; and P% w/w=6.0%.

3b Preparation of Film

In a manner analogous to that described in Example 1b (in which Example 1a is replaced by Example 3a and where P% w/w=2.5%) a 150 μm thickness film was obtained, with the following properties: acetone double rubs>100; K=32 s on a glass substrate. Further tests were carried out as described in the results section.

### EXAMPLE 4

4a Preparation of phosphorus-containing urethane acrylate oligomer

To a double jacketed two litre reaction vessel, connected to an oil bath and equipped with a stirrer, was added 166 g of IPDI, 352 g of the phosphorus-containing methacrylate prepared as described in Example 3a, 360 mg of DtBHQ and 360 mg of TNPP. The reaction mixture was stirred and heated at 70° C. and atmospheric pressure. To the reaction mixture was added 220 mg of DBTL and the temperature was maintained at 70° C. When the NCO value reached less than 1.45 meq/g, a mixture of 207 g of CAPA 200 (as described in Example 2a above) and 81 g of HDDA was added to the reaction mixture using a dropping funnel over a 2 hour period whilst the temperature was kept below 90° C. Then 360 mg of DtBHQ was added and the temperature was raised to 90° C. until the NCO value was less than 0.2%, to obtain as product a urethane acrylate with the following properties: H=11730 mPa.s, Gardner colour<2 G and P% w/w=2.4%.

4b Preparation of Film

In a manner analogous to that described in Example 1b, in which Example 1a is replaced by Example 4a, a 150 μm thickness film was obtained which was tested as described in the results section.

### EXAMPLE 5

5a Preparation of phosphorus-containing methacrylate monomer

(i) Stage One

To a double jacketed two litre reaction vessel, connected to an oil bath and equipped with a stirrer, was added 1420 g of glycidyl methacrylate, 1.25 g of methylhydroquinone, 14 g of sodium methoxide (NaOMe) and 7 g of calcium oxide (CaO). The reaction mixture was stirred and heated at 65° C. at atmospheric pressure. Then 1100 g of dimethylphosphonate was added through a dropping funnel over a 3 hour period and after an exotherm (100° C.) was observed the temperature was kept below 65° C. The temperature was then set to 80° C. and maintained at this value for 5 hours. The reaction mixture was then filtered under reduced pressure using a filter aid (that available commercially under the trade name Celatom from Eagle Picher Co.); to isolate a filtrate as product which was analysed by ³¹P-NMR to confirm the Michael addition of dimethylphosphonate onto the unsaturated double bound. The product obtained had the following properties: epoxy value=3.98 meq/g; H=30 mPa.s; and Gardner colour<1G.

(i) Stage Two

To a double jacketed two litre reaction vessel, connected to an oil bath and equipped with a stirrer, was added 1130 g of the Michael adduct [obtained as described in Example 5a(i)], 1.25 g of methylhydroquinone, 2.25 g of TNPP and 32 g of benzyltrimethylammonium chloride. The reaction mixture was stirred and heated at 110° C. at atmospheric pressure. Then 323 g of acrylic acid was added through a dropping funnel over 90 minutes. The temperature was then maintained at 110° C. and enough extra phosphorus epoxy compound [the Michael adduct from Example 5a(i)] was added in a sufficient amount to keep the difference between the epoxy value and the acid number less than 0.08 meq/g. The reaction mixture was heated until the epoxy value was less than 0.23 meq/g and the acid value was less than 0.15 meq/g (actual value was 9 mg KOH/g) to obtain as product an acrylated phosphorus compound with the following properties: OH number=179 mg KOH/g; acid number=8.2 mg KOH/g; epoxy value=0.16 meq/g; H=5570 mpa.s; Gardner colour<1 G; and P% w/w=10.3%.

5b Preparation of Film

An amount of 40 g of the methacrylated phosphorus containing monomer prepared as described in Example 5a was added to 50 g of EB 284 and to 10 g of HDDA to give a formulation of P% w/w=4.0%. This formulation was applied to several substrates with a wire rod and cured as described in Example 1b, to obtain a 150 μm thickness film which was tested as described in the results section.

### EXAMPLE 6

6a Preparation of phosphorus-containing urethane acrylate oligomer

To a double jacketed two litre reaction vessel, connected to an oil bath and equipped with a stirrer, was added 127 g of IPDI, 169 g of the phosphorus-containing monomer prepared as described in Example 5a and 20 mg of hydroquinone. The reaction mixture was stirred, heated at 40° C. and atmospheric pressure, and then 100 mg of DBTL was added and the reaction mixture was heated to 70° C. When the NCO-value was less than 1.93 meq/g, a mixture of 156 g of CAPA 200 (as described in Example 2a) and 48 g of HDDA and 30 mg of DBTL were added to the reaction mixture using a dropping funnel over a 1 hour period. Then the temperature was raised to 90° C. until the NCO value was less than 0.2%. The reaction mixture was then cooled at room temperature and stabilised with 20 mg hydroquinone and 160 mg of TNPP to obtain as product a urethane acrylate with the following properties: H=8280 mPas, Gardner colour<2G; and P% w/w=3.5%.

6b Preparation of Film

In a manner analogous to that described in Example 1b, in which Example 1a is replaced by Example 6a, a 150 μm thickness film was obtained which was tested as described in the results section.

### COMPARATIVE EXAMPLES A TO F

Comparative, prior art phosphorus containing monomers and polymers were also prepared and tested as follows. The prior art polymers were made into films some of which were tested as described herein.

Comp A

To a double jacketed two litre reaction vessel, connected to an oil bath and equipped with a stirrer, was added 150 g of IPDI and 105 mg of DtBHQ. The mixture was heated to 45° C. and this was added over two hours a mixture of 78 g of HEA, 105 mg DtBHQ and 131 mg of DBTL via a dropping funnel whilst the temperature was kept below 65° C. When the NCO value of the reaction mixture dropped below 2.96 meq/g a mixture of 297 g of a known phosphorus containing polyol (that available commercially from Akzo Chemical Inc. under the trade name Fyrol 51 and having an hydroxy value of 125 mg KOH/g) 131 mg of DBTL, 52 mg TNPP and 75 mg HDDA was added via a dropping funnel over two hours whilst the temperature was kept below 90° C. The reaction mixture was then heated until the NCO value was less than 0.2%. and then diluted with 296 g of HDDA to obtain as product a urethane acrylate with the following properties: H=6200 mPa.s, Gardner colour<2G and P% w/w=7.4%.

Comp B to F

In order to obtain formulations with decreasing P content the mixture obtained from Comp A above was further diluted with a mixture of HDDA and an aliphatic urethane acrylate (that available commercially from UCB S.A. under the trade designation EB 284) as indicated in Table 1 below to obtain comparative examples Comp B to Comp F.

TABLE 1
Comparative Examples

| Example | % Oligomer | % EB 284 | HDDA | % P w/w |
|---|---|---|---|---|
| Comp A | 100 | 0 | 0 | 7.4 |
| Comp B | 14 | 73 | 13 | 1.0 |
| Comp C | 41 | 50 | 9 | 3.0 |
| Comp D | 54 | 39 | 7 | 4.0 |
| Comp E | 68 | 27 | 5 | 5.0 |
| Comp F | 81 | 16 | 3 | 6.0 |

Results

A sample of each film prepared in Examples 1 to 6 above plus the comparative examples Comp B to F above were submitted to a thermogravimetric analysis (TGA) in which the sample was heated at a rate of 10° C./min under air atmosphere from room temperature up to 700° C. Comparative example “Comp A” was too brittle to form which could be tested.

Table 2 below, gives the weight % residues at 500° C. and at 600° C. in this TGA test for each Example of the invention herein and the comparative films which could be tested, as well as a non phosphorus containing film made from EB284 alone. At a given temperature, a higher char yield indicated that the material is a better flame retardant. The oxygen index (OI) was determined by using ASTM D 2863 for measuring the minimum oxygen concentration to support candle-like combustion of plastics. The test was applied to material of thickness 150 μm , using a test specimen of dimensions of 52 mm×140 mm.

The results for the Examples and the prior art are given in Table 2 (where “-” denotes not measured). Following the publication of M. Levin, S. M. Atlas, Eli M. Pearce, “Flame-Retardant Polymeric Materials”, Eds., Plenum Press, New-York (1975), p.376; a sample that has a Limit Oxygen Index (referred to hereinafter as LOI) measured in the above test which is higher than 20% is considered to be a flame retardant, either a slow burning composition (20%<LOI<27%) or a self extinguishing composition (LOI>27%). It can be seen from the data in Table 2 that all the Examples of the present invention can thus considered to be flame retardants by this definition.

The char yields and LOI of phosphorus containing urethane acrylates of the present invention containing different amounts of phosphorus by weight %, can be compared with the char yields and LOI of the prior art urethane acrylates. The data in Table 2 show that compared to the prior art materials, char yields and/or LOI for a given phosphorus level are much higher for films of the present invention than the comparative examples, illustrating their improved flame retardant properties.

TABLE 2
(Comparison of prior art and invention)

| | Char Yield (%) | Char Yield (%) | | |
|---|---|---|---|---|
| Example | @ 500° C. | @ 600° C. | P % w/w | LOI % |
| Comp A | 11 | 1 | 0 | 18.0 |
| (EB 284) | | | | |
| Comp B | 12 | 2 | 1.0 | 20.2 |
| Comp C | 16 | 2 | 3.0 | 21.6 |
| Comp D | 15 | 2 | 4.0 | 21.0 |
| Comp E | 19 | 3 | 5.0 | 25.0 |
| CompF | 21 | 2 | 6.0 | — |
| 4b | 20 | 9 | 2.4 | 21.3 |
| 2b | 19 | 13 | 2.5 | 21.7 |
| 3b | 20 | 12 | 2.5 | 22.0 |
| 1b | 24 | 9 | 3.5 | 22.8 |
| 6b | 22 | 14 | 3.5 | 23.1 |
| 5b | 25 | 22 | 4 | 25.2 |

1. A co-polymerisable phosphorus containing polymer precursor which comprises:
a) a polymerisable unsaturated bond,
b) a oxycarbonyl or iminocarbony group; and
c) a free hydroxy group or a functional group obtainable by reaction of a free hydroxy group with a suitable electrophile; and
d) a terminal phosphorus and oxygen containing group located at the end of a carbon chain and comprising at least one group selected from: hydroxy phosphorus and an optionally substituted hydrocarbyl group attached to a phosphorus atom through an oxy group;
where the polymer precursor:
is substantially free of halo comprising species;
has a molecular weight (Mₙ if a polymer) of from about 200 to about 5,000 daltons;
optionally, has a viscosity of less than about 14,000 mPa.s; and
the polymer precursor is other a compound represented by the following formula:
CH₂═CR′″¹CO₂CH₂CH(OH)CH₂OP(O)(OR′″²)(OR′″³)
where R′″ⁱ═H, Me; R′″²═C₁₋₂₄alkyl, C₆₋₂₀(alk)aryl, C₇₋₁₂aralkyl; R′″³═H, C₁₋₂₄alkyl, C₆₋₂₀(alk)aryl, C₇₋₁₂aralkyl;

2. A polymer precursor as claimed in claim 1, which comprises a compound of Formula 1: 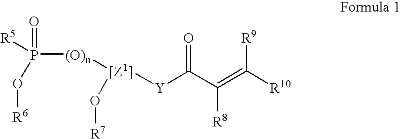
in which:
n is 0 or 1;
Y represents oxy oroptionally substituted imino;
[Z¹] independently represents a multivalent organic linking moiety connecting the moieties to which it is attached in Formula 1;
R⁵ represents H or an optionally substituted C₁₋₃₀organo group:
R⁶ represents H or an optionally substituted C₁₋₃₀hydrocarbyl; and
R⁷, R⁸, R⁹ and R¹⁰ independently represent H and/or an optionally substituted C₁₋₃₀organo group;
with the proviso that
when: n is 1; R⁵ is C₁₋₂₄alkoxy, C₆₋₂₀(alk)aryloxy or C₇₋₁₂aralkoxy; R⁶ is H, C₁₋₂₄alkyl, C₆₋₂₀(alk)aryl, or C₇₋₁₂aralkyl; R⁷ is H; Z¹ is —CH₂(CH—)CH₂—; Y is oxy; R⁸ is H or methyl, and R⁹ is H; then R¹⁰ is other than H.

3. A polymer precursor as claimed in claim 2, in which [Z¹] represents an optionally substituted C₁₋₁₂organo group.

4. A polymer precursor as claimed in either claim 2 or 3, in which R⁵ is selected from the group consisting of: optionally substituted C₁₋₁₈hydrocarbyl and optionally substituted C₁₋₁₈hydrocarbyloxy.

5. A polymer precursor as claimed in any of claims 2 to 4, in which R⁶ is optionally substituted C₁₋₁₈hydrocarbyl.

6. A polymer precursor as claimed in any of claims 2 to 5, in which R⁷ is selected from the group consisting of: H and an optionally substituted C₁₋₁₈organo group.

7. A polymer precursor as claimed in any of claims 2 to 6, in which R⁸, R⁹ and R¹⁰ are independently selected from at least one of the group consisting of: H and an optionally substituted C₁₋₁₂hydrocarbyl.

8. A polymer precursor represented by any of the following formulae: 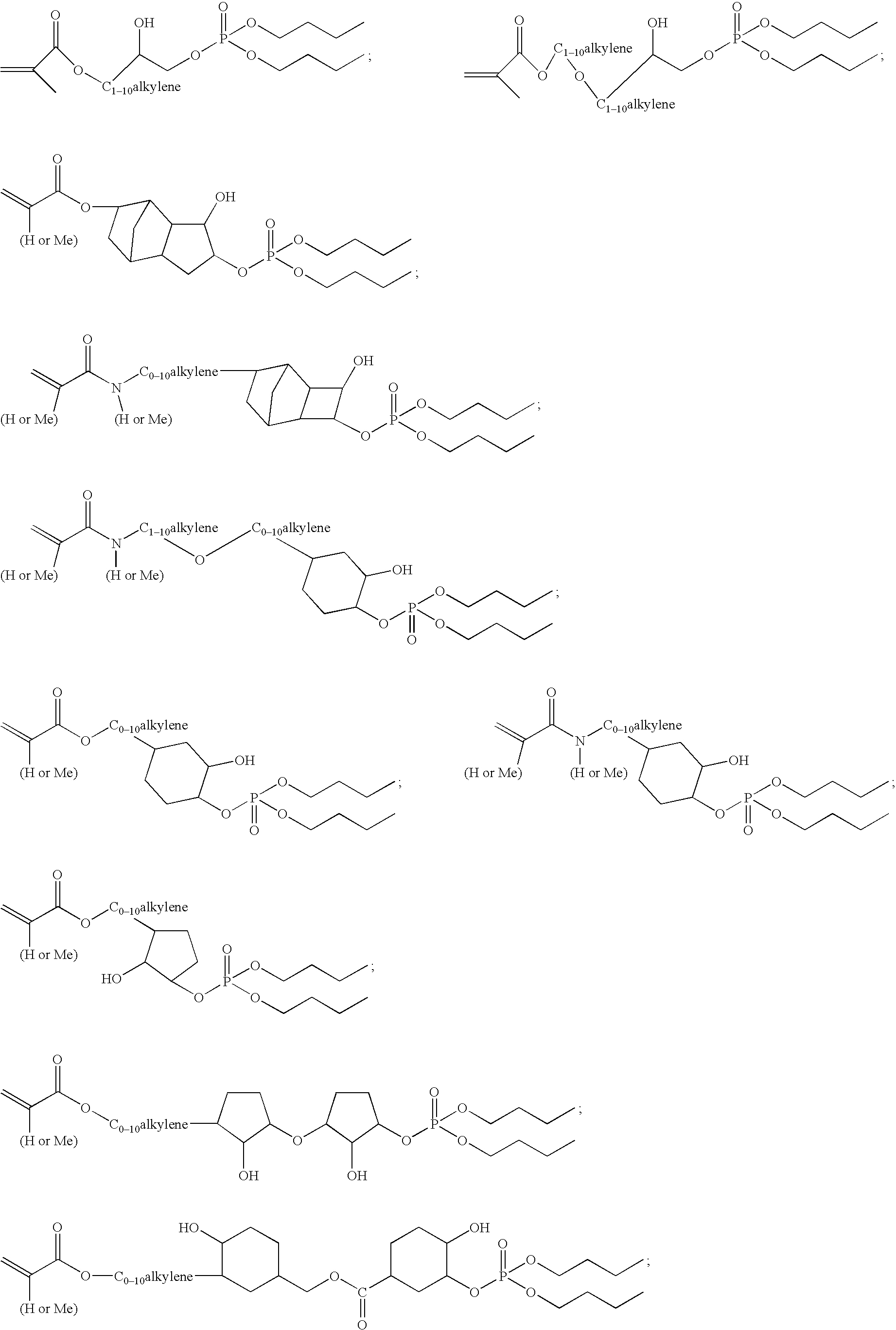 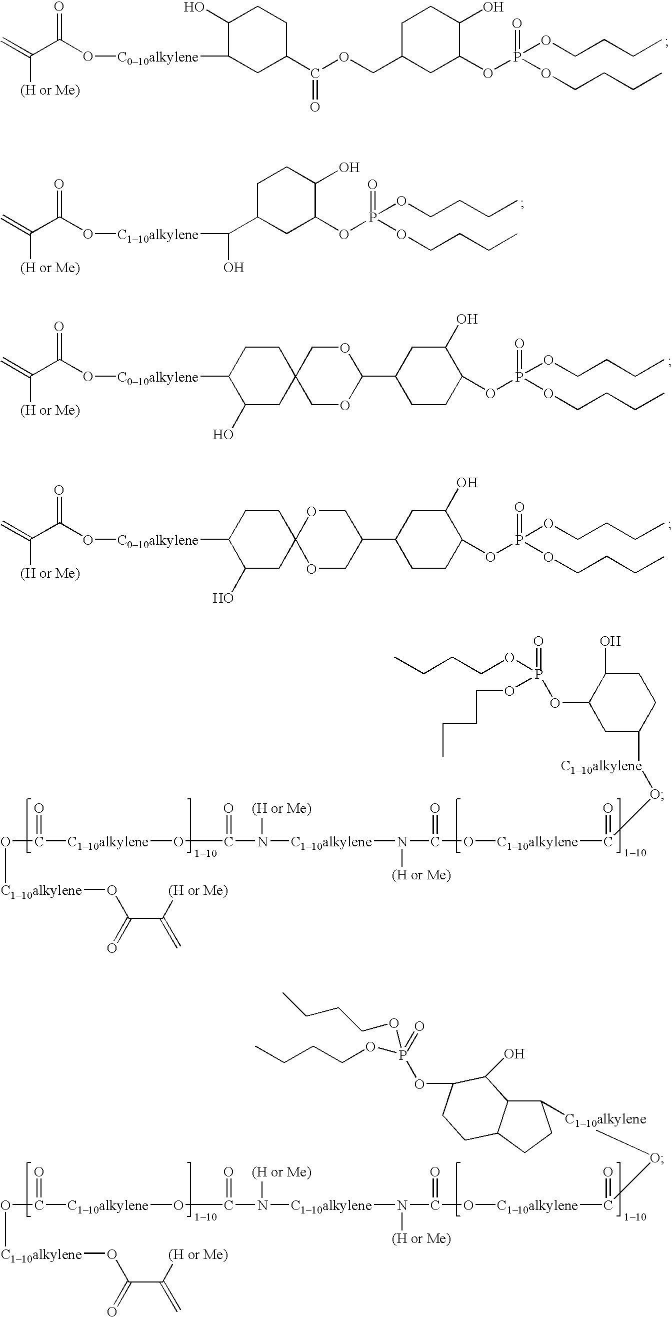 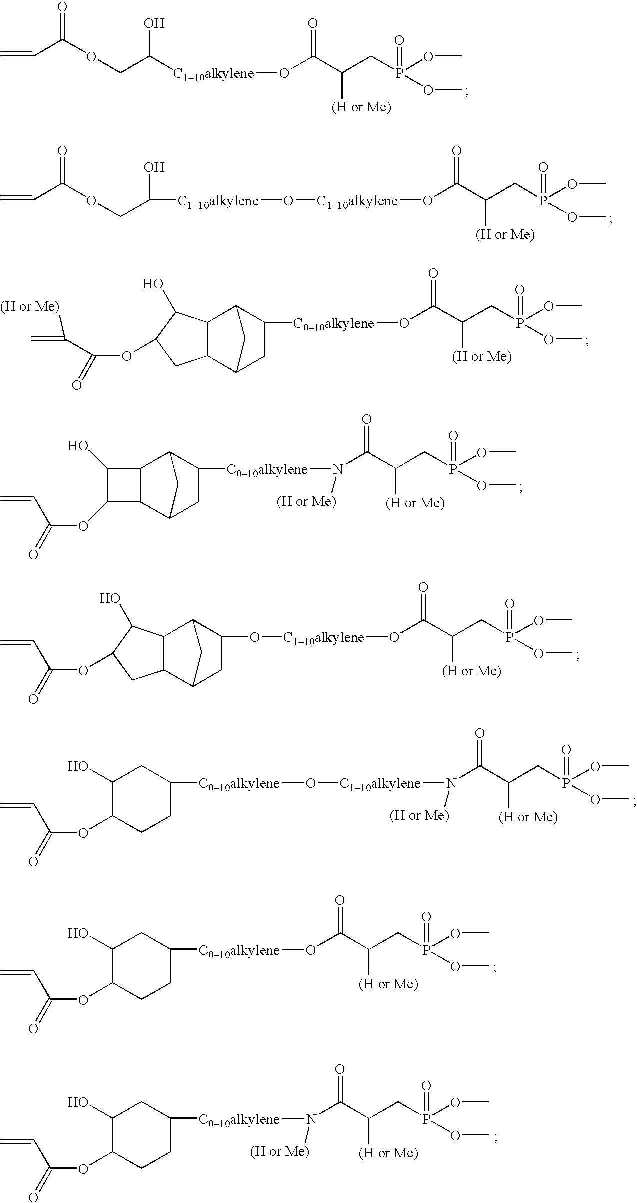 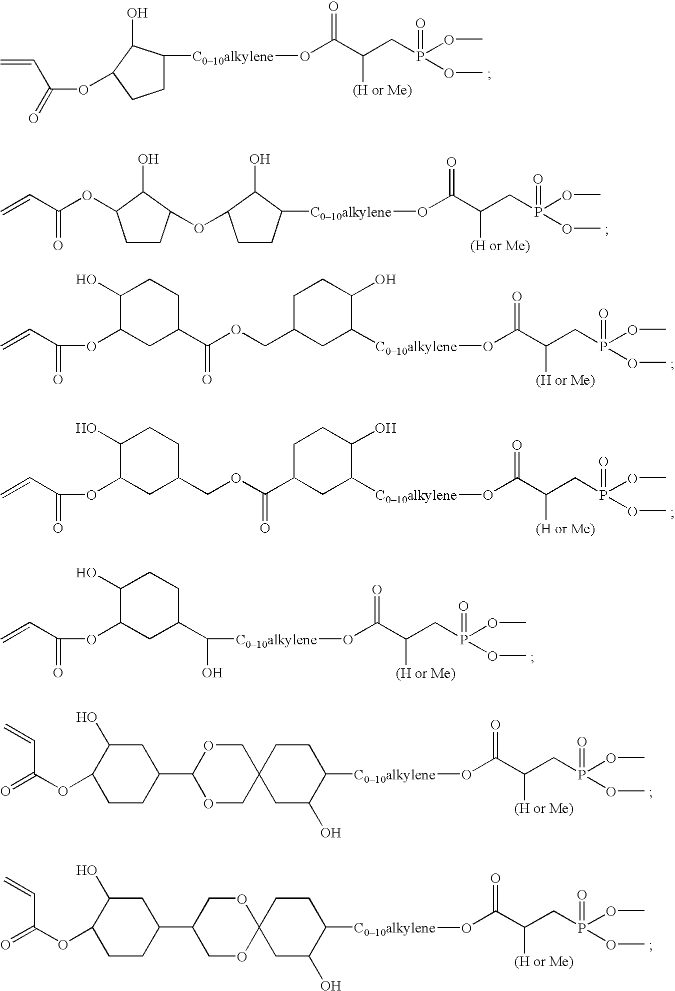 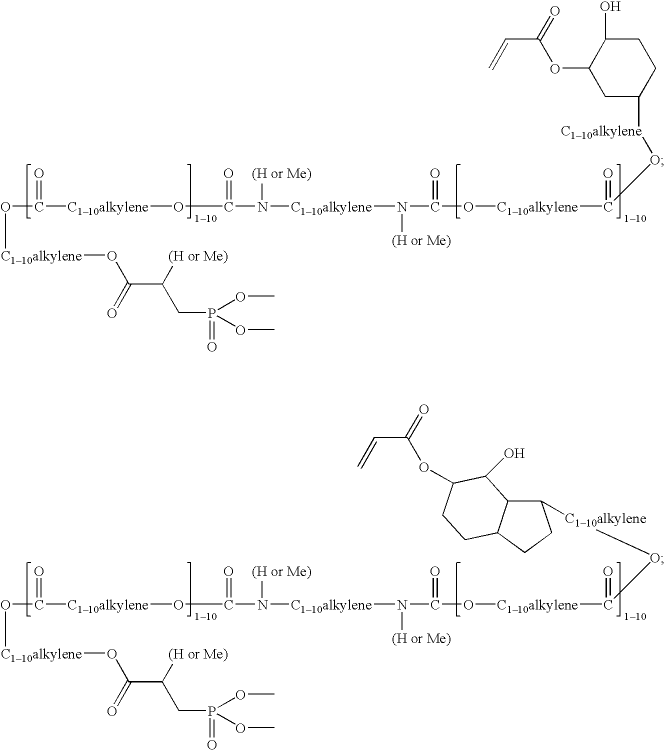
and/or all effective isomers thereof.

9. An organic compound or polymer comprising at least one optionally substituted cycloalkoxy group where at least one of the ring atoms is oxygen in which the cycloalkoxy is linked to at least one optionally alpha-substituted alkylidenylcarbonyloxy group comprising at least one active hydrogen beta to the carbonyl where:
a) at least one of the cycloalkoxy group(s) is capable of reacting with a phosphate ester to form a terminal phosphate ester group having a hydroxy on the beta carbon atom; and/or
b) at least one alkylidenylcarbonyloxy group is capable of reacting with an H-phosphonate ester to form a terminal phosphonate ester group beta to a carbonyloxy group and optionally at least one of the cycloalkoxy group(s) is capable of reacting with a carboxylic acid group conjugated with an unsaturated group to form an carbonyloxyhydroxyalkyl group adjacent an unsaturated carbon bond;
in either or both case such that the resultant product would comprise at least one phosphorus atom, at least one hydroxyl group and at least one polymerisable, unsaturated carbon bond.

10. A process for preparing a substantially halo free phosphorus-containing (co)polymerisible polymer precursor comprising:
a) a polymerisable unsaturated bond,
b) a oxycarbonyl or iminocarbonyl group;
c) a free hydroxy group or a functional group obtainable by reaction of a free hydroxy group with a suitable electrophile; and
d) a terminal phosphorus and oxygen containing group located at the end of a carbon chain and comprising at least one group selected from: hydroxy phosphorus and an optionally substituted hydrocarbyl group attached to a phosphorus atom through an oxy group;
the process comprising the step of reacting
(i) a compound comprising at least one oxirane group and at least one optionally substituted alkylidenylcarboxy group; with
(ii) a compound comprising at least one terminal phosphorus and oxygen containing group located at the end of a carbon chain and comprising at least one group selected from: hydroxy phosphorus and an optionally substituted hydrocarbyl group attached to a phosphorus atom through an oxy group.

11. A process as claimed in claim 10, in which the compound (i) comprises a compound of Formula 2: 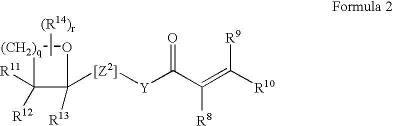
in which,
q represents 0 or an integer from 1 to 3, most preferably 0 or 1, for example 0;
r represents 0, or if q is other than 0, an integer from 1 to q;
Y represents NMe, NH or O;
R⁸, R⁹, R¹⁰ are independently as represented as described in any of claims 2 to 7;
R¹¹, R¹², R¹³ and R¹⁴ represent, independently in each case, H or an optionally substituted organo group; and
[Z¹] represents an optionally substituted multivalent organic linking group.

12. A process which comprises the steps of:
(a) reacting
(i) an organic compound or polymer comprising at least one optionally substituted cycloakoxy group where at least one of the ring atoms is oxygen in which the cycloalkoxy is linked to at least one alkylidenylcarbonyloxy group with:
(iii) one or more reactant(s) comprising, in the same or different reactant(s); and added either separately or together:
(1) at least one phosphate ester which reacts with at least one of the cycloalkoxy group(s) of reactant (i) to form a terminal phosphate ester group with an hydroxy substituent on the adjacent carbon atom; and/or
(2) at least H-phosphonate ester which reacts with at least one of the alkylidenylcarbonyloxy group(s) of reactant (i) to form a terminal phosphonate ester group adjacent a carbonyloxy group;
and then in an optional step (b):
(b) adding a moiety comprising a carboxylic acid group conjugated with an unsaturated group which reacts with at least one of any remaining cycloalkoxy group(s) in the product of the reaction (a) to form another product comprising a carbonyloxyhydroxyalkyl group adjacent an unsaturated carbon bond;
in either or both case such that the final product comprises at least one phosphorus, at least one hydroxyl group and at least one polymerisable, unsaturated carbon bond.

13. A process as claimed in claim 12, in which the unsaturated carboxylic acid used in optional step (b) of the process of the invention comprises a compound of Formula 3 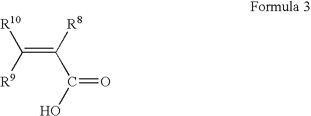
in which R⁸, R⁹ and R¹⁰ are independently as represented in any of claims 2 to 7.

14. A process as claimed in either claim 12 or 13, in which the phosphorus ester reactant comprises a compound of Formula 4 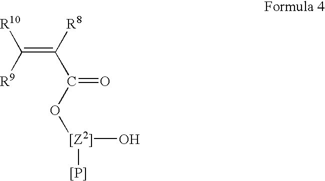
in which R⁸, R⁹, R¹⁰ and [Z²] are independently as represented in any of claims 2 to 7 or 11, and [P] denotes a terminal phosphate ester group or a terminal phosphonate ester group.

15. A process as claimed in any of claims 12 to 14, in which the phosphorus ester reactant is selected from a compound of Formula 5 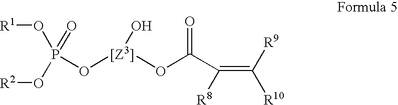
and/or a compound of Formula 6 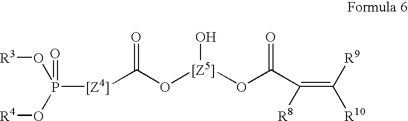
in which R¹, R², R³, R⁴, R⁸, R⁹ and R¹⁰ are independently as represented in any of claims 2 to 7; and
[Z³], [Z⁴] and [Z⁵] both independently represent [Z¹] or [Z²] as described in any of claims 2 to 7 or 11.

16. A polymer precursor obtained and/or obtainable by a process as claimed in any of claims 10 to 15 and which comprises at least one phosphorus, at least one hydroxyl group and at least one polymerisable unsaturated bond.

17. A polymerisation method for preparing a phosphorus containing polymer in which the method comprises a first step of initiating polymerisation in the presence of a polymer precursor as claimed in any of claims 1 to 9 and/or 15, said polymer precursor optionally being used as a reagent, co-monomer and/or end capper in combination with other optional ingredients selected from one or more (co)polymer precursor(s), catalyst(s), initiator(s), cross-linker(s) and/or other additive(s); followed by an optional second step of halting polymerisation and isolating the resultant polymer.

18. A phosphorus containing polymer obtained and/or obtainable by the polymerisation method of claim 17.

19. A polymer as claimed in claim 18, which comprises a polyurethane copolymer having one or more phosphorus groups pendant from the polymer chain.

20. A polymer as claimed in either claim 16 or 18, which is represented by Formula 7: 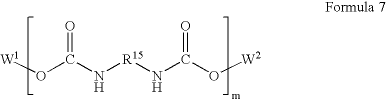
in which
m is from about 1 to about 100; and
R¹⁴ represents independently in each repeat unit, a suitable C₁₋₁₈organo linking group, and
W¹ and W² independently represent a phosphorus end capping group of Formula 8: 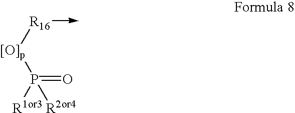
where R¹, R², R³ and R⁴ are independently as represented in any of claims 2 to 7;
p is 0 or 1; and
R¹⁵ represents a C₁₋₁₈organo linking group which optionally comprises a polymerisable functionality;
and where the polymer is substantially free both of halo species and of free P—OH groups; and has an average molecular weight of at least about 1,000 daltons.

21. A polymeric composition obtained and/or obtainable by further polymerisation of a polymer and/or polymer precursor as described any of claims 1 to 9, 16, or 18 to 20 which is optionally substantially cross-linked to form a network of linked polymer chains to form a film and/or coating, the resin comprising within the polymer chain or network one or more pendant phosphorus moieties of Formula 9: 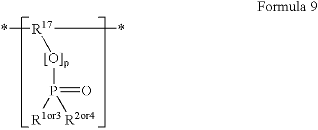
where R¹, R², R³, R⁴ and p are independently as described herein, and
R¹⁷ independently represents a multivalent C₁₋₁₈organo group;
together with one or more other effective repeat units optionally comprising a urethane linkage.

22. A first flame retardant product, component for said first product and/or consumable for use with said first product, which comprises at least one co-polymer precursor as claimed in any of claims 1 to 9 and/or 16 and/or at least one polymer as claimed in any of claims 18 to 20 and/or a polymeric composition as claimed in claim 21.

23. A second product which has utility in one or more non-flame retardant applications; optionally selected from the group consisting of anti-corrosion, pigmentary dispersion and/or adhesion promotion; a component for said second product and/or a consumable for use with said second product, the second product comprising at least one co-polymerisable phosphorus containing polymer precursor and/or polymer obtained and/or obtainable from such a polymer precursor; in which the polymer precursor comprises:
a) a polymerisable unsaturated bond.
b) a oxycarbonyl or iminocarbonyl group; and
c) a free hydroxy group or a functional group obtainable by reaction of a free hydroxy group with a suitable electrophile; and
d) a terminal phosphorus and oxygen containing group located at the end of a carbon chain.

24. Use of at least one substance selected from the group consisting of:
a) a polymer precursor as claimed in any of claims 1 to 9 and/or 16;
b) at least one polymer as claimed in any of claims 18 to 20; and
c) a polymeric composition as claimed in claim 21;
in the manufacture of at least one of the following:
(i) an effective first product as claimed claim 22;
(ii) an effective second product as claimed in claim 23; and/or
(iii) a component and/or consumable for use with the product(s) as claimed in either of claims 21 and 22.

25. Use in flame retardancy, anti-corrosion, pigmentary dispersion and/or adhesion promotion of at least one item from the group consisting of:
(a) a polymer precursor as claimed in any of claims 1 to 9 and/or 16;
(b) a polymer as claimed in any of claims 18 to 20;
(c) an effective first product as claimed claim 22;
(d) an effective second product as claimed in claim 23; and/or
(e) a component and/or consumable for use with the product(s) as claimed in either of claims 21 and 22.

26. A polymer precursor or polymer substantially as described herein with reference to the examples.

27. The use of at least one co-polymerisable phosphorus containing polymer precursor to prepare an optionally end capped urethane acrylate; the polymer precursor comprising
a) a polymerisable unsaturated bond,
d) an oxycarbonyl or iminocarbonyl group;
e) a free hydroxy group or a functional group obtainable by reaction of a free hydroxy group with a suitable electrophile; and
d) a terminal phosphorus and oxygen containing group located at the end of a carbon chain and comprising at least one group selected from: hydroxy phosphorus and an optionally substituted hydrocarbyl group attached to a phosphorus atom through an oxy group;
and where the polymer precursor is substantially free of halo comprising species.

28. A use as claimed in claim 27, in which the polymer precursor comprises a compound of Formula 1A: 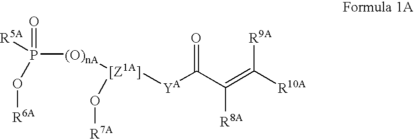
in which:
the polymerisable unsaturated bond is represented by the moiety “—C(R^{8A})═CR^{9A}R^{10A”}
the oxycarbonyl or iminocarbony group is represented by the moiety “—Y^{A}(C═O)—”;
the free hydroxy group or a functional group obtainable by reaction of a free hydroxy group with a suitable electrophile is represented by the moiety “—OR^{7A}”; and
the terminal group comprising phosphorus and oxygen is represented by the moiety of Formula AA: 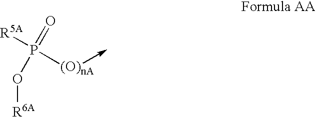
and where in Formula 1A:
“n^{A}” is 0 or 1 (i.e. when n^{A} is 0 the P atom is directly attached to the [Z^{1A}] moiety);
Y represents oxy or optionally substituted imino,
[Z^{1A}] independently represents a muitiivaient (for example tri- or tetra-valent) organic linking moiety (which may be an atom or group such as any suitable organo group) connecting the moieties of Formula AA; “Y^{A}(C═O)—”; and “—OR^{7A}”;
R^{5A} represents H or an optionally substituted C₁₋₃₀organo group;
R^{6A} represents H or an optionally substituted C₁₋₃₀hydrocarbyl;
R^{7A}, R^{8A}, R^{9A} and R^{10A} independently represent H and/or an optionally substituted C₁₋₃₀organo group.

29. A method of making an optionally end capped urethane acrylate by reacting at least one co-polymerisable phosphorus containing polymer precursor comprising:
a) a polymerisable unsaturated bond,
b) an oxycarbonyl or iminocarbonyl group;
c) a free hydroxy group or a functional group obtainable by reaction of a free hydroxy group with a suitable electrophile; and
d) a terminal phosphorus and oxygen containing group located at the end of a carbon chain and comprising at least one group selected from: hydroxy phosphorus and an optionally substituted hydrocarbyl group attached to a phosphorus atom through an oxy group;
and where the polymer precursor is substantially free of halo comprising species.

30. A method as claimed in claim 29, in which the polymer precursor comprises a compound of Formula 1A as represented in claim 28.

31. An optionally end capped urethane acrylate obtained and/or obtainable by reacting at least one co-polymerisable phosphorus containing polymer precursor comprising:
a) a polymerisable unsaturated bond,
b) an oxycarbonyl or iminocarbonyl group;
c) a free hydroxy group or a functional group obtainable by reaction of a free hydroxy group with a suitable electrophile; and
d) a terminal phosphorus and oxygen containing group located at the end of a carbon chain and comprising at least one group selected from: hydroxy phosphorus and an optionally substituted hydrocarbyl group attached to a phosphorus atom through an oxy group;
and where the polymer precursor is substantially free of halo comprising species.

32. A urethane acrylate as claimed in claim 31, in which the polymer precursor comprises a compound of Formula 1A as represented in claim 28.

33. Use as a flame retardant of at least one co-polymerisable phosphorus containing polymer precursor comprising:
a) a polymerisable unsaturated bond,
b) an oxycarbonyl or iminocarbonyl group;
c) a free hydroxy group or a functional group obtainable by reaction of a free hydroxy group with a suitable electrophile; and
d) a terminal phosphorus and oxygen containing group located at the end of a carbon chain and comprising at least one group selected from: hydroxy phosphorus and an optionally substituted hydrocarbyl group attached to a phosphorus atom through an oxy group;
and where the polymer precursor is substantially free of halo comprising species.

34. A use as claimed in claim 33, in which the polymer precursor comprises a compound of Formula 1A as represented in claim 28.

35. Use to prepare a flame retardant, of at least one co-polymerisable phosphorus containing polymer precursor comprising:
a) a polymerisable unsaturated bond,
b) an oxycarbonyl or iminocarbonyl group;
c) a free hydroxy group or a functional group obtainable by reaction of a free hydroxy group with a suitable electrophile; and
d) a terminal phosphorus and oxygen containing group located at the end of a carbon chain and comprising at least one group selected from: hydroxy phosphorus and an optionally substituted hydrocarbyl group attached to a phosphorus atom through an oxy group;
and where the polymer precursor is substantially free of halo comprising species.

36. A use as claimed in claim 35, in which the polymer precursor comprises a compound of Formula 1A as represented in claim 28.

37. Method of making as a flame retardant composition comprising reacting and/or incorporating into a composition at least one co-polymerisable phosphorus containing polymer precursor comprising:
a) a polymerisable unsaturated bond,
b) an oxycarbonyl or iminocarbonyl group;
c) a free hydroxy group or a functional group obtainable by reaction of a free hydroxy group with a suitable electrophile; and
d) a terminal phosphorus and oxygen containing group located at the end of a carbon chain and comprising at least one group selected from: hydroxy phosphorus and an optionally substituted hydrocarbyl group attached to a phosphorus atom through an oxy group;
and where the polymer precursor is substantially free of halo comprising species.

38. A method as claimed in claim 37, in which the polymer precursor comprises a compound of Formula 1A as represented in claim 28.
